(19) United States
(12) Patent Application Publication
(10) Pub. No.: US 2006/0080819 A1
(43) Pub. Date: Apr. 20, 2006

(54) Systems and methods for deployment and recycling of RFID tags, wireless sensors, and the containers attached thereto

(76) Inventor: Clarke W. McAllister, Eugene, OR (US)

Correspondence Address: STOEL RIVES LLP, 900 SW FIFTH AVENUE, SUITE 2600, PORTLAND, OR, 97204-1268, US

(21) Appl. No.: 11/226,885

(22) Filed: Sep. 14, 2005

Related U.S. Application Data
(60) Provisional application No. 60/610,021, filed on Sep. 14, 2004.
(60) Provisional application No. 60/611,577, filed on Sep. 20, 2004.
(60) Provisional application No. 60/614,011, filed on Sep. 27, 2004.
(60) Provisional application No. 60/617,173, filed on Oct. 8, 2004.
(60) Provisional application No. 60/629,744, filed on Nov. 19, 2004.
(60) Provisional application No. 60/632,301, filed on Nov. 30, 2004.
(60) Provisional application No. 60/634,874, filed on Dec. 9, 2004.
(60) Provisional application No. 60/637,939, filed on Dec. 20, 2004.
(60) Provisional application No. 60/647,683, filed on Jan. 26, 2005.

(51) Int. Cl. H01B 15/00

(52) U.S. Cl. 29/403.3

(57) ABSTRACT

Disclosed are embodiments of apparatus, systems, and methods for deploying and/or recycling wireless tags, such as RFID tags and wireless sensors, and the containers they may be attached to. Also disclosed are improved RFID tag and wireless sensor configurations. In one configuration, an RFID tag/wireless sensor system is described that leaves RFID tags and wireless sensors undamaged and capable of reuse through numerous cycles. Methods are also disclosed for reducing waste and pollution resulting from wireless tags contaminating existing recycled waste streams.

### RELATED APPLICATIONS

This application claims the benefit under 35 U.S.C. § 119(e) of U.S. Provisional Patent Application No. 60/610,021, filed Sep. 14, 2004, and titled “Systems and Methods for Deployment and Recycling of RFID Tags.” This application also claims the benefit under 35 U.S.C. § 119(e) of U.S. Provisional Patent Application No. 60/611,577, filed Sep. 20, 2004, and titled “Systems and Methods for Deployment and Recycling of RFID Tags.” This application also claims the benefit under 35 U.S.C. § 119(e) of U.S. Provisional Patent Application No. 60/614,011, filed Sep. 27, 2004, and titled “Systems and Methods for Deployment and Recycling of RFID Tags.” This application also claims the benefit under 35 U.S.C. § 119(e) of U.S. Provisional Patent Application No. 60/617,173, filed Oct. 8, 2004, and titled “Systems and Methods for Deployment and Recycling of RFID Tags.” This application also claims the benefit under 35 U.S.C. § 119(e) of U.S. Provisional Patent Application No. 60/629,744, filed Nov. 19, 2004, and titled “Systems and Methods for Deployment and Recycling of RFID Tags.” This application also claims the benefit under 35 U.S.C. § 119(e) of U.S. Provisional Patent Application No. 60/632,301, filed Nov. 30, 2004, and titled “Systems and Methods for Deployment and Recycling of RFID Tags and Wireless Sensors.” This application also claims the benefit under 35 U.S.C. § 119(e) of U.S. Provisional Patent Application No. 60/634,874, filed Dec. 9, 2004, and titled “Systems and Methods for Deployment and Recycling of RFID Tags and Wireless Sensors.” This application also claims the benefit under 35 U.S.C. § 119(e) of U.S. Provisional Patent Application No. 60/637,939, filed Dec. 20, 2004, and titled “Systems and Methods for Deployment and Recycling of RFID Tags and Wireless Sensors.” This application also claims the benefit under 35 U.S.C. § 119(e) of U.S. Provisional Patent Application No. 60/647,683, filed Jan. 26, 2005, and titled “Systems and Methods for Deployment and Recycling of RFID Tags, Wireless Sensors, and the Containers Attached Thereto.” Each of the aforementioned provisional patent applications are incorporated herein by specific reference.

### BRIEF DESCRIPTION OF THE DRAWINGS

Understanding that drawings depict only certain preferred embodiments of the invention and are therefore not to be considered limiting of its scope, the preferred embodiments will be described and explained with additional specificity and detail through the use of the accompanying drawings in which:

FIG. 1 depicts a UHF RFID inlay with a single dipole antenna structure.

FIG. 2 is a diagrammatic view of layers of materials used to construct a printable “smart label.”

FIG. 3 depicts a UHF inlay with an adaptive-tuning triflex antenna.

FIG. 4 is a block diagram of a high-functionality wireless tag.

FIG. 5 is a flowchart of a method to reuse cartons and wireless tags.

FIG. 6 is a diagrammatic view of a dual dipole tag with a variable width slit and seal.

FIG. 7 is a diagrammatic view of a single dipole tag with a variable width slit and printable seal.

FIG. 8 is a flowchart of a method for tag or inlay recycling using a panel and taped regions.

FIG. 9 is a flowchart of a method for RFID tag recycling.

FIG. 10 is a flowchart of a method for inlay recycling using selectively-applied adhesive on a panel.

FIG. 11 is a flowchart of a method to sort recyclable containers and to remove and reuse wireless tags attached to them.

FIG. 12 is a block diagram of a tag sort controller.

FIG. 13 is a flow chart of a method for inlay sorting and recycling using tag data.

FIG. 14 is a flowchart of a method of inlay sorting and recycling using passwords.

FIG. 15 is a diagrammatic view of a dipole microstrip antenna constructed on a substrate.

FIG. 16A is a diagrammatic illustration of methods for placing a tag in or on a container.

FIG. 16B is a diagrammatic illustration of additional methods for placing a tag in or on a container.

FIG. 17 depicts a prism-shaped three-dimensional transponder placed in a container and adjacent to items in the container.

FIG. 18 depicts a T-shaped three-dimensional transponder placed in a container and between bottles of liquid.

FIG. 19 is a flowchart of a comprehensive method for facilitating transponder reuse.

FIG. 20 presents a diagrammatic view illustrating how tag data points may be authenticated to trusted database records.

FIG. 21 is a flowchart of a tag authentication process.

FIG. 22 is a diagrammatic view of a closed-loop RFID tagging method.

FIG. 23 is a flowchart of a closed-loop RFID tagging method.

FIG. 24 is a diagrammatic view of an adhesive smart label that can be removed.

FIG. 25 is a diagrammatic view of an extracted patch of tagged OCC.

FIG. 26 is a flowchart of a method for recovering RFID patches from tagged OCC.

FIG. 27 is a diagrammatic view illustrating RFID patches being compressed from tagged OCC.

FIG. 28 is a flowchart of a comprehensive RFID tag recycling method.

FIG. 29 is a diagrammatic view of a glued panel that carries an RFID inlay.

FIG. 30 is a flowchart of a method for removing and reusing tags on recyclable containers.

FIG. 31 is a diagrammatic view of a machine used to salvage RFID tags from a repulper.

FIG. 32 is a diagrammatic view of a cryogenic tag removal tank.

### DETAILED DESCRIPTION OF PREFERRED EMBODIMENTS

Described below are various embodiments of methods, systems, and apparatus relating to wireless tags. In the following description, numerous specific details are provided for a thorough understanding of the embodiments of the invention. However, those skilled in the art will recognize that the invention can be practiced without one or more of the specific details, or with other methods, components, materials, etc.

In addition, in some cases, well-known structures, materials, or operations are not shown or described in detail in order to avoid obscuring aspects of the invention. Furthermore, the described features, structures, or characteristics may be combined in any suitable manner in one or more embodiments.

Certain preferred embodiments and implementations will now be described. Some of the disclosed embodiments include apparatus, systems, and methods for deploying and/or recycling wireless tags, such as RFID tags and wireless sensors, and the containers they may be attached to. Also disclosed are improved RFID tag and wireless sensor configurations. In one configuration, an RFID tag/wireless sensor system is described that leaves RFID tags and wireless sensors undamaged and capable of reuse through numerous cycles. Methods are also disclosed for reducing waste and pollution resulting from wireless tags contaminating existing recycled waste streams.

Some of the disclosed methods involve tagging transportation containers. In most instances, the tagging methods will be described with reference to containers such as paperboard boxes, corrugated cartons, pharmaceutical bottles, pharmaceutical containers, and conveyable cases, but other containers may be used by these methods. Certain embodiments relate to commercial corrugated shipping cartons, RFID or wireless sensors, tagged pallet-loads of shrink-wrapped cases, consumer goods packaging, consumer goods, or to other various methods of tagging objects in such a manner that the tags can easily be removed for subsequent repetitive cycles of cleaning, testing, sorting, interrogation, reconditioning, reprogramming, and reuse. Corrugated cases are typically constructed with an inner and an outer linerboard, between which a corrugated medium is glued.

There are several terms that are used in various parts of this disclosure that warrant explicit definition.

Reuse is primarily used in this disclosure as a verb to mean “to use again, especially after salvaging or special treatment or processing.”

Recycling refers to methods that involve reprocessing of materials. According to the U.S. Environmental Protection Agency, recycling turns materials that would otherwise become waste into valuable resources and generates a host of environmental, financial, and social benefits.

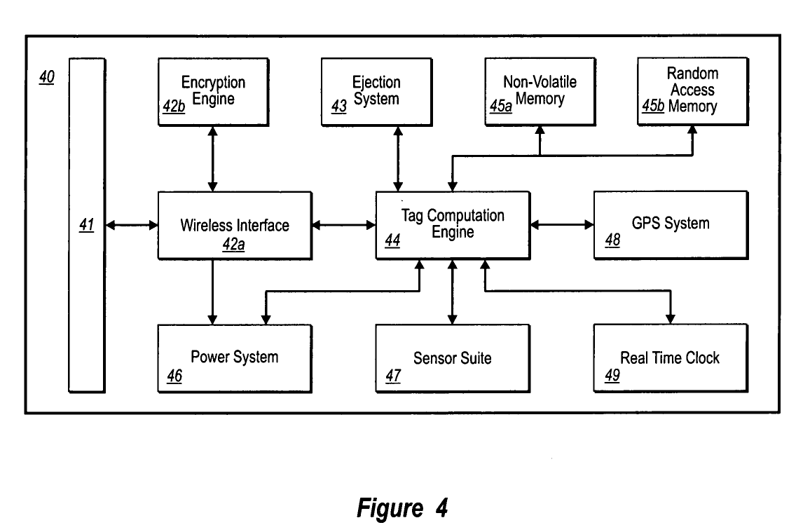

This document refers to transponders interchangeably with the term tags. A transponder is generally fabricated from an inlay and additional materials that may include a substrate material. This document refers to the term inlays interchangeably with the term inlet. An inlay is a thin segment of plastic such as PET that carries an antenna structure bonded to at least one RFID chip or other type of wireless sensor device. Though many of the embodiments herein are described with reference to various inlays, inlets, transponders and RFID tags, the methods and devices described herein may be applicable to other types of wireless tags, transponders, or wireless sensors. Wireless tags are a broad class of wireless devices that transmit and receive information wirelessly, have a unique identity, and optionally sense one or more attributes within its environment. Wireless tags include RFID transponders, RFID tags, RFID inlays, RFID inlets, and wireless sensors. Wireless sensors are devices that report identity, and or some combination of additional information such as temperature, moisture, sunlight, seismic activity, biological, chemical or nuclear materials, specific molecules, shock, vibration, location, or other environmental parameters. Wireless tags are distributed nodes of computing networks that are interconnected by wired and wireless interfaces. Wireless tags may be made using silicon circuits, polymer circuits, optical modulation indicia, an encoded quartz crystal diode, or Surface Acoustic Wave (SAW) materials to affect radio frequency or other signaling methods. Wireless tags may be used to communicate wirelessly to an interrogator, and some such embodiments of wireless tags communicate on a peer-to-peer basis. Communication methods may include narrow band, wide band, ultra wide band, or other means of radio or signal propagation methods. FIG. 4 is a block diagram of an embodiment of a wireless tag that, when properly queried, reports certain sensor measurements in addition to one or more identification codes.

Some transponder embodiments include RFID tags or wireless sensors as a component. Other tag embodiments include RFID inlays as a component. Still other embodiments use printed RFID or wireless sensor electronic circuits and printed antenna as a means of constructing an RFID tag or wireless sensor without using an RFID inlay. Such circuit printing methods may include the use of polymers to construct circuit elements instead of fabricating circuits on silicon, germanium, or other semiconductor substrate material.

This disclosure refers to objects that are associated with RFID tags and are referred to by the data within RFID tag memories. Such objects may include, but are not limited to: passports and other forms of identification, money, currency, books, CD's, DVD's, and other creative media, manufactured sub-assemblies, pharmaceuticals, medical supplies, electronic components, consumer goods, manufactured goods, waste containers, shipping containers, and industrial equipment. RFID tags and wireless sensors can be embedded in plastic, paper, preformed materials, or other manufactured items.

Discarded means separation from a material flow or process that results in transportation of that item to another place using best material handling or waste disposal practices.

“Waste stream” refers to the total flow of solid waste from homes, businesses, institutions, and manufacturing plants that is recycled, burned, or disposed of in landfills, or segments thereof such as the “residential waste stream” or the “recyclable waste stream.”

Exemplary categories of tag attachment include:

1) Several techniques are described for adapting conventional label attachment machinery, such as those that use pressure sensitive adhesives to attach bar coded shipping labels. This type of machinery may be used to directly apply a transponder or wireless tag, or attach it within a pocket, packet, panel, seal, carrier, or pouch using a pressure sensitive adhesive bonded to the face of a transport container. This machinery may also be capable of combining materials such as wireless tags or transponders and transponder packaging at the point of attachment.

2) Conveyor line or other high speed machinery with automated adhesive application and attachment of tags, prefabricated packets, pockets, panels, or pouches that seal, contain, or carry transponders or wireless tags—either new or remanufactured.

3) Hand attachment of tags, prefabricated packets, pockets, panels, seals, carriers, or pouches that contain or carry transponders or wireless tags (a method that is referred to as “slap and ship”).

In some of the methods disclosed herein, transponder or tag removal from a shrink-wrapped pallet, shipping container, transport container, box, shrink wrap, delivery envelope, tube or parcel may be performed in one simple, easy manual or automatic operation. The time and place of such removal may vary depending on the specific application, but in general occurs when there is no commercial need for the tag and its associated object to remain physically attached. Examples of such moments are upon delivery of a parcel, upon emptying of or preparation to crush, or repulping of a container, upon unwrapping of a wrapped shipment of cases on a pallet, or upon delivery of a tagged part in a manufacturing or maintenance operation. Another example of such a moment is a pharmaceutical representative, nurse, or office manager restocking certain drug samples in a doctor's office by opening a case of drugs, removing the contents, removing the transponder, and transferring it to a desired location for certain remanufacturing steps disclosed herein.

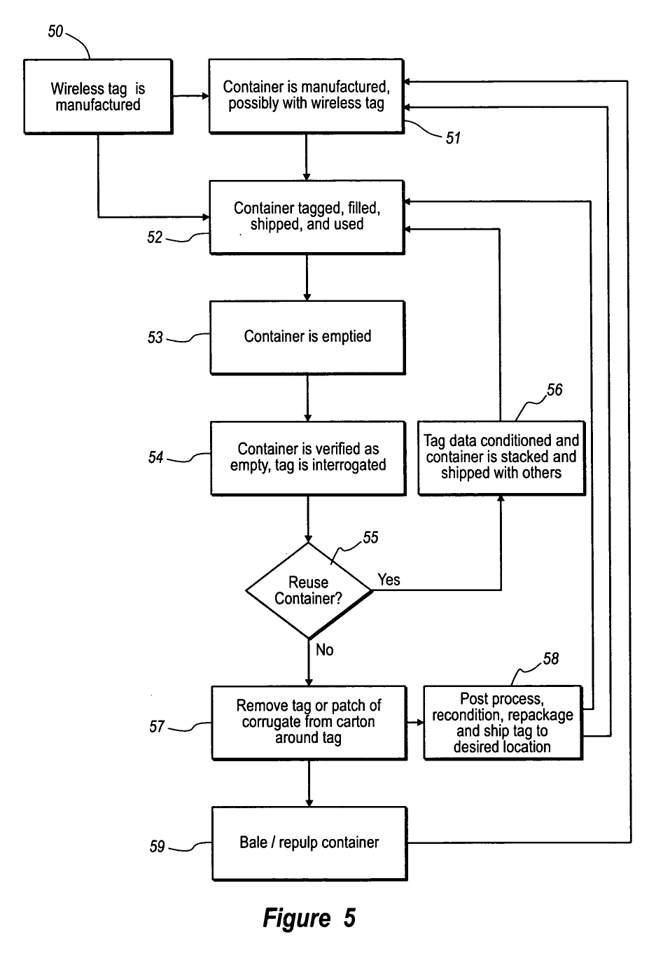

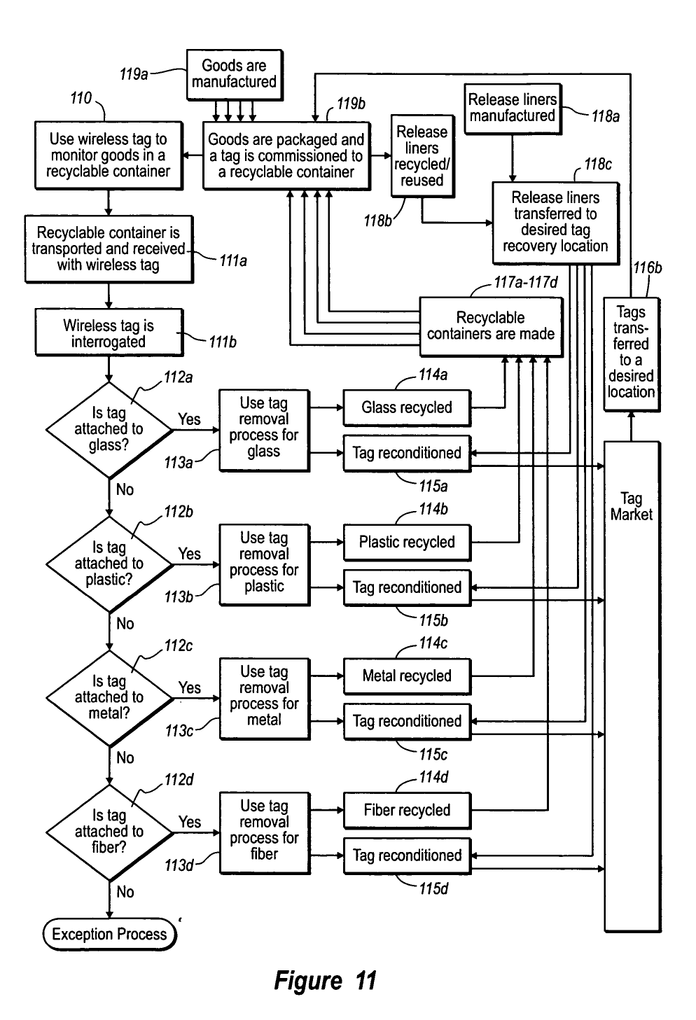

Recovery of wireless tags may also be performed in a series of steps at different locations. One such method is to initially separate the tag from most, but not necessary all, of the transport container, and then transport that partially-cleaned tag to another location in order to remove most or all of the remaining container material. Such processes are illustrated in FIGS. 5 and 11

In some implementations, the wireless tags may be mechanically reconditioned for reuse. Mechanically reconditioning a tag includes any physical manipulation of the tag that places the tag in a preferable condition for reuse, such as, for example, cleaning, sawing, slicing, trimming, rolling, folding, and repackaging of the tags to prepare them for reuse. In some implementations, the wireless tags may also be categorized for reuse. Categorizing the tags for reuse includes any information-gathering process overlaid onto a database of information about a variety of tag types and conditions, such as, for example, sorting, testing, grading, weighing, inspecting, and data extraction. In some implementations, the wireless tags may also be logistically prepared for reuse. Logistically preparing the tags for reuse includes any logical, packaging, or material handling operation intended to prepare tags for subsequent commissioning and reuse, such as, for example, changing data (i.e., data scrubbing), passwords, application identifier bits or control bits, loading application-ready tags into a cartridge, storing mechanical, electrical, or chemical energy in a cartridge, and reinitializing data related to a cartridge, and transfer or shipment to some desired location.

Attachment to and removal of an RFID tag or transponder to and from its associated object may be, in some embodiments, done with great care to assure that the tag is well-suited to being reused or recycled. Its value after reprocessing may depend greatly on designs, methods, practices, and processes that preserve the tag's original condition and functionality. If the tag or transponder is donated to a non-profit organization or other third party that would entitle the donor to a tax credit or deduction, then the amount of the tax benefit may depend on the quality and value of the donated tag. A non-profit organization that receives donated tags can assess the value of the donation, and issue statements of that value to the donor and to any appropriate taxing authorities. Such appraisals may be based on certain relevant physical, mechanical, electrical, and electronic quality measurement parameters. In the case of a semi-passive or active tag, an appraisal may also include a valuation on the charge life remaining in the battery. Value appraisals for each tag or transponder may be performed using automated machinery, such as the type shown in FIG. 31, and may have the capabilities described herein.

Another value of donating tags is to avoid wasteful disposal of transponders or wireless tags. Electronic waste may consist of obsolete discarded electronic products that contain constituent materials that are harmful to the environment or the recycling processes of the object that they are attached to. Electronic waste is collected by various organizations and is referred to as eWaste. Because of their constituent materials and short life cycle, RFID and wireless tags typically become eWaste. Certain reporting mechanisms described in this disclosure may be used to report the number and type of wireless tags recovered or disposed of by certain companies and organizations in order to properly assign goodwill to those for expending the effort to avoid wasteful damage to the earth's environment or to assess or rebate eWaste fees or fines as may be required under certain laws. The value of ethical behavior in many cases exceeds monetary values, but is moot under certain eWaste laws that require that an eWaste fee be paid at the time a wireless tag is purchased or commissioned for use. Such fees may be used to pay for the cost of recycling, reusing, or destroying used RFID tags or wireless sensors.

Statements of donations or eWaste disposals may be generated by an automated system that receives information from the automated machinery that performs the aforementioned automated value assessments. Generating such a statement may include steps such as:

1) Reading data from the RFID tag to determine the Manufacturer Code or a Company Prefix as defined by EPCglobal US out of Lawrenceville, N.J. (“EPCglobal”);

2) Using at least one database to look up the legal name of the company that is registered to ship products using that Manufacturer Code or Company Prefix;

3) Naming the legal name of that registered company in a donation or eWaste disposal statement;

4) Listing the tags or transponders that were donated or disposed of, possibly including descriptive information such as:

a. Manufacturer, model, type, class, variety;

b. Quality or condition of the donated/recovered tag;

c. Location and business tag was received from; and

d. Some or all of the data that was stored on the tag.

5) Assigning a donation value or eWaste disposal fee or rebate based on a combination of factors, such as:

a. The results of automated testing of that tag,

b. Historical records of the Fair Market Value for tags of that particular model, type, age, and condition in a particular geographic region;

c. An assessment of the economic benefit or damage to incrementally reducing or increasing pollution to air, water, and soil;

d. An assessment of the economic benefit or damage of incrementally reducing or increasing contamination in the world's supply of recycled corrugate, glass, or plastic;

e. An assessment of the incremental reduction or increase in adhesive, metal, batteries, and plastic contributed to the world's landfills;

f. The amount most recently paid for that tag;

g. The amount typically paid for a tag of that model, type, age, and condition in a particular geographic region; and

h. A flat rate fee for certain eWaste listed RFID tags.

Statements may also be generated by an automated system for companies, organizations, or individuals that donate time and labor to find, salvage, detach, collect, accumulate or harvest used RFID tags or transponders. Transponder harvesting can be related to a variety of RFID tagging applications. For example, supply chain applications include harvesting tags from both commercial packaging and consumer packaging applications. In the latter case, consumers may prefer to remove RFID tags from goods that they purchase and then deposit them in a collection bin. The foregoing steps can be used to credit them with returning those tags to a recycling program. That step of crediting a consumer may be performed using records from a transaction database to help resolve the identity of that consumer in order to issue them credit. Generating such statements or reports may, for example, include the steps of:

1) Reading a tag or other identifier that designates what registered company, organization, or individual is to be credited for harvesting a population of accumulated used RFID tags;

2) Using at least one database to look up the legal name of the company, organization, or individual that is registered to harvest and donate used RFID tags or transponders;

3) Naming the legal name of that registered company, organization, or individual in a donation statement or tag return credit program;

4) Listing the tags or transponders that were donated or returned, possibly including descriptive information such as:

a. Manufacturer, model, type, class, variety;

b. Quality or condition of the donated tag;

c. Location from which the business tag was received; and

d. Some or all of the data that was stored on the tag.

5) Using pre-approved labor values for salvaging, detaching, accumulating, transporting, or otherwise providing donated labor to the recovery and donation of donated RFID tags, and reporting those values for the type of tag or types of tags that are donated or returned. Such pre-approved rates may be authorized by governmental taxing bodies, the Internal Revenue Service, certified public accounts, and other concerned accounting organizations.

Donated used RFID tags that do not meet certain minimum requirements for being reused may be recycled for the value of their constituent materials, the value of which may be recognized and reported in statements to donors and government taxing authorities.

RFID tags may be read at multiple points in the collection, accumulation, and harvesting processes. Such points may include: the point of detachment; a point of any secondary detachment steps or operations; the first point of accumulation; the first point of combining with other collections of accumulated tags or transponders; subsequent points of combining quantities of accumulated tags or transponders; and all points where wireless tags are sorted by model, type, sensing capabilities, age, color, appearance, quality, demand, geographic need, shipper, logistics provider, goods manufacturer, or other parameter for evaluation.

Donors of tags and labor to harvest tags may receive donor statements that are automatically generated. Such statements may be issued in electronic format and transmitted through a secure Internet connection.

One embodiment uses more than one RFID chip bonded to the same antenna structure. Such a multiple chip embodiment has the advantage of redundancy compared to a single antenna inlay. The chips and antenna may also be impedance-matched using strip line techniques to assure maximum power transfer between chips and antenna.

Another transponder embodiment uses more than one inlay to increase the overall reliability of the transponder. One embodiment uses two inlays arranged side-by-side, each operating independently, sharing the same transponder substrate. Another embodiment uses two inlays arranged at right angles to each other, or at some oblique angle.

UHF is an acronym for Ultra High Frequency. UHF refers to the band of the electromagnetic spectrum that, for RFID applications, spans from about 860 MHz to 960 MHz. RFID tags responsive to this frequency band generally have some form of one or more dipoles in their antenna structure. Since monopoles require a ground plane, they are not typically used in low cost passive RFID applications.

Another embodiment is directed to a transponder that uses more than one inlay, each inlay tuned to a specific part of the UHF RFID spectrum that is associated with various regulatory jurisdictions. For example:

1) one inlay may be tuned for optimal use in the 860-870 MHz band. Such a transponder may be well suited to use in European countries;

2) a second inlay may be tuned to 902-928 MHz that may be preferred for use in North American countries; and

3) a third inlay may be tuned to 930-960 MHz that may be preferred for use in some Asian countries.

Another advantage of using separate inlays that are tuned to various frequency sub-bands is that a different RFID integrated circuit may be used to support various preferred protocols that may be associated with various geographic regions.

For example, a transponder may have two inlays, one inlay that is optimized for use in China, and a second inlay that is optimized for use in the United States. If certain RFID protocols and operating frequencies are preferred in China that are different than certain protocols and frequencies that are preferred in the United States, then two inlays may be applied to a common transponder structure.

Transponder structures may be either planar or three dimensional.

Ultra Wide Band (UWB) is a method of transmitting radio pulses across a very wide spectrum of frequencies that span several gigahertz of bandwidth. Modulation techniques include the use of Orthogonal Frequency Division Multiplexing (OFDM) to derive superior data encoding and data recovery from low power radio signals. OFDM and UWB provide a robust radio link in RF noisy or multi-path environments and improved performance through and around RF absorbing or reflecting materials compared to narrowband, spread spectrum, or frequency-hopping radio systems. UWB wireless sensors may be reused according to certain methods disclosed herein. UWB wireless sensors may be combined with narrowband, spread spectrum, or frequency-hopping inlays or wireless sensors as disclosed herein.

Multiple sets of data can be carried on a transponder in any of several ways, including but not limited to:

1) multiple memory partitions within an RFID IC;

2) multiple RFID ICs on a common antenna structure;

3) multiple RFID IC's on separate antennae structures; or

4) multiple tags on a common transponder substrate.

Certain embodiments use a data set for object identification and another data set for permanently identifying a transponder. For such embodiments, the object identity data will change for each use, but the transponder identification in some embodiments may not change.

Certain RFID tag or wireless sensor embodiments use passwords and/or encryption to prevent unauthorized viewing of data. Doing so enhances security and privacy and also creates a barrier to counterfeiters that would otherwise clone certain tags or transponders for mass production of counterfeit goods that each bear one of multiple instances (i.e. copies) of valid tag data.

A method is disclosed below whereby unique and permanent tag data is used as an index into a trusted database in order to detect and thwart counterfeiting.

In another embodiment, a transponder comprises RFID inlays using end fire YAGI antenna structures to direct backscatter radiation along a narrow beam path that is coplanar with the inlay. This is in contrast to dipole radiation patterns that radiate outward in a direction that is normal to the inlay face. A directional microstrip antenna may include a driven element, an isolated reflector, and at least one isolated coplanar director. In some embodiments, all antenna elements are aligned perpendicular to the axis of the end fire beam directivity. The dimensions of a YAGI antenna structure can be greatly reduced by designing the antenna elements for use on high dielectric materials. The size of antenna elements scales downward with the inverse square of the dielectric constant of the substrate material.

An advantage of an end fire directed beam is to provide improved gain at preferred angles relative to a transport container such as corrugated cartons, and how they are arranged on pallets for shipping to and from distribution centers.

In one configuration, the transponder may have two inlays, each with directional YAGI antennae that are tuned for different bandwidths and center frequencies. The overall direction of the resulting radiation patterns can be made to be at oblique or orthogonal angles to each other.

Passive RFID refers to tags without batteries. Active tags have batteries and have been historically been considerably more expensive than passive RFID tags. Passive RFID tags backscatter incident RF energy. Active RFID tags often have their own transmitter and generally do not use backscatter for the return link. A battery assist tag is a sort of hybrid that uses a battery to power the RFID chip and a backscatter return link to the interrogator.

The RFID inlays are fundamentally an RFID chip bonded to an antenna, formed on a substrate that is often plastic such as Mylar®, polyester, or PET. Antennae may be formed by etching copper from the substrate, but an alternate method is to print multiple layers of conductive ink onto a substrate.

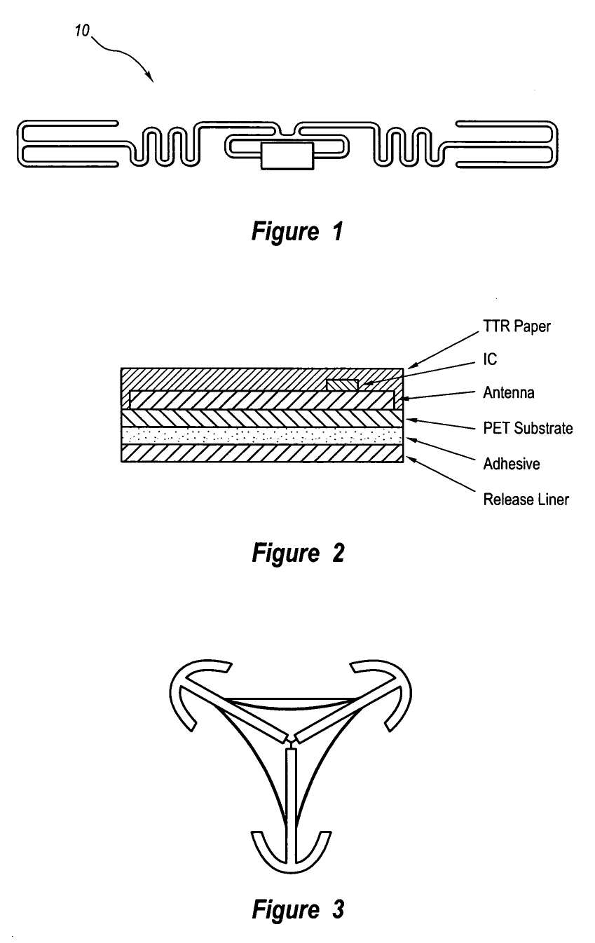

FIG. 1 illustrates a configuration for a UHF RFID tag/inlay having a single linear dipole antenna structure made from etched copper.

FIG. 2 illustrates the layers of material used to fabricate the inlay shown in FIG. 1 combined with a layer of paper to create a “smart label” with a printable face material (also referred to as facestock).

FIG. 3 illustrates a UHF inlay manufactured by Avery Dennison, a corporation headquartered in Pasadena, Calif., which has the ability to automatically compensate for a range of conditions that would otherwise detune a tag from its resonant frequency.

This inlay, as well as certain other designs, may also be optionally combined with a shield and/or a dielectric spacer behind the antenna to create a tag that performs well over a broad range of packaging conditions. A robust design may also include features to protect the tag from damage.

Additional transponder layers have been developed by Power Paper Ltd., a company headquartered in Israel. Power Paper has developed technology that enables the mass production of low-cost, thin and flexible energy cells capable of powering a host of applications. Power Paper's technology is a process that enables the printing of caseless, thin, flexible and environment-friendly energy cells on a polymer film substrate, by means of a simple mass-printing technology and proprietary inks. Power Paper cells are composed of two non-toxic, widely-available commodities: zinc and manganese dioxide. The cathode and anode layers are fabricated from proprietary ink-like materials that can be printed onto virtually any substrate, including specialty papers. The cathode and anode are produced as different mixes of ink, so that the combination of the two creates a 1.5-volt battery that is thin and flexible. Unlike conventional batteries, Power Paper's power source does not require casing. UHF-based battery-assisted backscatter tags can operate at about twice the range of a passive RFID tag. UHF battery-assist RFID tags and battery-powered UWB wireless sensors represent a class of devices that warrant reuse according to some methods disclosed herein.

FIG. 4 illustrates an embodiment of a wireless tag 40. The wireless tag 40 includes an antenna system 41, memories 45a and 45b, a sensor section 47, and may include further components as described below. The antenna system 41 may be tuned and optimized for the preferred frequency and bandwidth required for interrogation by RFID readers, access points, or other wireless tags on a peer-to-peer basis.

Wireless Interface 42a includes means to receive and transmit digital information through a medium wirelessly, such as for example an IEEE802.11, IEEE802.15, or an EPCglobal compliant interface, potentially using modulated electromagnetic signals. Wireless Interface 42a may also include one or more state machines to execute one or more preferred sets of Wireless Interface protocols. Wireless Interface 42a may also utilize certain secure modes of data transfer, some of which may involve using data encryption. Wireless Tag 40 includes Encryption Engine 42b to perform certain data encryption and decryption functions in support of Wireless Interface 42a. Some embodiments of Wireless Tag 40 are also capable of updating encryption algorithms, keys, and methods used by Encryption Engine 42b.

Certain embodiments of Wireless Tag 40 include parts of subsystems: Ejection System 43, Tag Computation Engine 44, Random Access Memory 45b, Sensor Suite 47, GPS System 48, and Real Time Clock 49.

Tag Computation Engine 44 may perform certain tag management, supervisory, and resource allocation functions for Wireless Tag 40. It executes instructions which may be stored in read-only memory embedded within Tag Computation Engine 44, Non-Volatile Memory 45a, and Random Access Memory 45b.

GPS System 48 may use a constellation of terrestrial or satellite based points of reference to calculate the instantaneous location of Wireless Tag 40. GPS System 48 may also report location information to Tag Computation Engine 44 when queried or when programmed to do so spontaneously when certain events occur including, for example: when a change of location is detected, or a certain amount of time has passed since that last report.

Real Time Clock 49 may be used to correlate certain other information with time, and may further report time when queried by Tag Computation Engine 44, or spontaneously when certain predetermined events occur including: certain preset alarm conditions, or periodic time intervals such as hourly.

Sensor Suite 47 may include one or more sensors such as: temperature, pressure, barometric pressure, humidity, moisture, shock, vibration, acoustical sound, seismic activity, images, video images, sunlight, molecular detectors, biological, chemical, or nuclear materials.

Power System 46 acquires, stores, and distributes power within Wireless Tag 40, potentially harvesting power from a variety of available sources including: Wireless Interface 42a, light, fuel cell, battery, magnetic induction, electric fields, or other means.

Ejection system 43 disclosed herein may release Wireless Tag 40 from a host substrate. Tag ejection mechanisms include activation of a release mechanism in one or more mechanical latches, an array of micro-machine latches, changing the molecular alignment or crystalline structure that binds Wireless Tag 40 to a host substrate, or reversal of adhesive bonds, such as Diels-Alder Adducts, through activation of a localized heat source.

Useful applications of the Real Time Clock include: reporting when Wireless Tag 40 arrived at a certain location, time-stamping sensor readings, or waking up certain subsystems within Wireless Tag 40 in order to report or record certain information.

Referring now to FIG. 5, a method is disclosed by which corrugated cartons that are used as supply chain or retail transport containers are processed to recover and reuse wireless tags and optionally to reuse the tagged transport container as well.

The first step 50 of FIG. 5 is to manufacture a wireless tag (i.e. tag, wireless sensor, RFID tag, inlay, inlet, or transponder). Wireless tags are shipped in bulk quantities to a place where they are prepared for attachment.

Step 51 is to manufacture a corrugated carton. This is a well-known process that involves an initial step of manufacturing linerboard and medium from pulp. Medium is glued between linerboards to form a flat sheet of uncut corrugate of specified weight and thickness. Corrugated sheets may be affixed with wireless tags, and then die cut into specific patterns. An alternative method is to first die cut the sheet into patterns, and then optionally apply a wireless tag. Certain printing and surface finishes are also applied at various times in this process. Containers are stacked and shipped flat to packaging or manufacturing plants.

Step 52 is to open and fill a container with goods. If the container was manufactured with an embedded or pre-applied wireless tag, then each of those tags may be tested and encoded with supply chain information. If not, then a wireless tag may be tested and encoded with supply chain information, then applied to the carton, either before or after the carton is filled, depending on the preferred process for that specific application. The carton is sealed and used to transport goods to a desired destination.

If cartons are reused, then they may be sealed using methods that allow it to be opened, unpacked, flattened, palletized, shipped flat, reopened at a packaging or manufacturing plant, refilled, and resealed over the course of numerous use cycles.

In some embodiments, a carton, especially one having a reusable seal, may utilize a wireless tag with the ability to sense where and when a carton is opened or closed. Such a wireless tag may have a sensor which may be part of a sensor suite, such as sensor suite 47 of FIG. 4, to detect that the carton has been opened or closed. Such a sensor may be a light sensitive detector, a photovoltaic cell, a capacitive or charge sensing circuit, a pair of electrical contacts, or some other low power environmental sensor. Upon detection of such an event, a record may be made in non-volatile memory 45a of wireless tag 40, as shown in FIG. 4. Real Time Clock 49 may be used to provide a timestamp for the record of such an event. GPS System 48 may be capable of being used to provide a location stamp for such a record, as well as other event records of interest. The re-sealable carton may then be shipped to a desired destination.

Records of important events may be read from the wireless tag by authorized persons for purposes that include maintaining security within a supply chain.

Step 53 is to empty the container, preferably at a desired and authorized location.

Step 54 is to verify that the container is actually empty. This step is often performed by the worker who unloaded the carton in Step 53, but may also be performed by persons or systems charged with the duty of loss prevention. Certain wireless sensors may the capability to determine if the carton is empty or not, and can signal to an interrogator if the carton is about to enter the recycle waste stream without having been completely emptied.

An automated emptiness verification system may include a method of sensing if something other than empty cartons is entering the recycle waste stream at a particular location. One such method is to interrogate all wireless tags on cartons entering the recycle waste stream at locations such as waste container consolidation. Information from the wireless tags may be used to determine measurable parameters that are characteristic of an empty carton, such as: weight, silhouette, or capacitance. Although such information may be acquired directly from the wireless tag, it may also be obtained through queries of one or more databases that contain such information in a secure and possibly locally cached location.

One or more scales or load cells may be used to determine the weight of a container to detect if it is heavier than it should be. One or more electrodes, metal detectors, and charge transfer circuits may be used to determine if detectable amounts of waste stream contamination is present. Tactile sensors, or linear imagers, or area imagers may be used to inspect the silhouette or outline of a container to determine if it is larger than normal. If any of these or other measurements detect conditions outside of what is considered normal for an empty carton of that type, then further steps may be taken to determine if saleable goods are in the container.

A record of this event may be made in tag 40 and/or the information system charged with monitoring supply chain activity in that zone. The wireless tag may also be interrogated to determine if the tag can be rewritten with new information. If the tag cannot be rewritten, then it may be of little use beyond this point. Conditions that may prevent its reuse include the tag being locked to prevent alteration of the data therein. Certain tags can fortunately be unlocked such that they can be reprogrammed. Tags of this type may use a password to unlock the tag. Knowing the password expedites the unlocking process, and proving that the password is correct may be accomplished before expending cost and effort to reuse it and/or the container that it is attached to.

Step 55 is to determine if the tag and the carton it is attached to will be reused as a single entity. Making this decision may include interrogation of the tag or using interrogation data from the previous step to determine the type of tag and/or carton it is. This information may then be used to query one or more databases to determine the market value of the tag by itself, and/or the market value of the tag combined with the container that it is attached to. Using a certain set of predetermined operational rules, the decision is made to reuse the carton and tag combination or not. Action may be taken to divert the carton to a separate recycle or reuse waste stream beginning at step 56.

All tags that are to be reused without the carton they are attached to are sent on to step 57.

Step 56 is to prepare the container for reuse. The wireless tag may be prepared by scrubbing sensitive or proprietary data from the tag. Certain embodiments also may write new tracking information into the wireless tag to facilitate its identification along the reverse logistics path to a packaging or manufacturing plant. Certain embodiments also protect the wireless tag by encoding one or more passwords into tag in order to enhance security and/or privacy.

The carton/tag combination may be stacked flat with other cartons of the same type. As described in step 52, these cartons may have reusable seals with a means of detecting if the seal has been broken or the carton opened at unauthorized or unplanned times and places. The stack of cartons may be shipped to a desired packing or manufacturing plant.

Step 57 is to use information that was acquired in step 54 to determine where a reusable wireless tag is located on the carton. Such information may include any or all of the following: tag interrogation data, image data, and capacitive charge transfer data, all of which may be used in certain methods to electronically locate a wireless tag attached to a container.

Image data may be acquired from linear imagers that scan along the outer surfaces of the carton or from area imagers that inspect the exterior of the carton. Both types of imagers can be either monochrome or color, sensing in various parts of the visible and non-visible light spectrum. Certain imagers sensing in non-visible light bands of the electromagnetic spectrum including ultra-wide band and microwave imagers may penetrate container walls to reveal metallic antenna structures that are indicative of the physical location of any wireless tag within the field of view. Imagers may report detailed information about the location and orientation of any wireless tags on any surface of the carton. Both types of imagers may also detect and process symbols, standard markings (such as ADASA, AIM and EPCglobal marks), bar codes, and human readable text to determine presence, location, and orientation of tags and smart labels. Certain embodiments compare acquired images to a template of graphical feature layouts that are known to be normally associated with the detected wireless tag. Each of the structures described above are examples of means for locating wireless tags attached to containers.

Once the precise locations of the wireless tag and/or smart label are determined, then, for example, an automated extraction device or devices may be used to extract them from the path into the corrugated recycle or reuse waste stream. Certain embodiments for executing this function are described and detailed in other parts of this disclosure.

Once the wireless tag, inlay, inlet, transponder, smart label, or patch of corrugate that they are attached to are extracted from the carton, the carton is sent back into the OCC recycle waste stream. An OCC baler may be a preferred point of collecting and consolidating used corrugated containers.

Step 58 is to perform certain post processing procedures that may be performed in a high capacity tag reprocessing facility. Step 58 may include any necessary procedures to prepare a wireless tag for reuse in a particular application. In certain embodiments, recovered inlays are encapsulated or used as a component to create a tag or transponder for subsequent reuse. Some of the reconditioning steps may not be performed until a customer has specified how tags are to be packaged, marked, or even pre-encoded with supply chain data. Some of the procedures are described herein, and they may be performed in various orders and sequences that are appropriate to certain circumstances.

In certain embodiments, wireless tags may be monitored to obtain information regarding one or more performance parameter. Performance parameters may include, for example, measurements of: required activation energy, backscatter signal strength, frequency response, read range, number or percentage of successful reads, sensor performance, or other parameters. The performance parameter information may be assessed and used to determine, for example, whether the wireless tag is suitable for reuse.

Certain embodiments sort tags according to various criteria including: the results of testing, ability to unlock the tag for reuse, tag type, tag manufacturer, CPG supplier, market demand, back orders for particular tags, or customer requested ship dates. Customer information may be acquired using a customer relationship management system or a system to conduct web-based transactions and trading. Sorting may also be used to apply preferred tag removal procedures and means to particular tags and the transport container that they are attached to. Sorting by tag type and by the product information that is encoded therein assures that the preferred procedures, parameter settings, and removal embodiments are used to produce efficient, high yield tag removal results. For example, cold or cryogenic tag removal processes will produce optimal yield and throughput when properly sorted and applied to certain tag and container types.

Certain embodiments include the ability to store tags for further post processing at a later time. A preferred method is to allocate storage space in certain bins on an automated tag or OCC patch sorting line. Conveyors are one means of transporting tags or tagged patches from a sorting location to a designated storage bin. Other methods of material handling may also be used, such as moving storage bins into warehouse storage locations.

Certain methods may involve making certain that tags are unlocked and available for reuse and, if they remain locked, to try a sequence of procedures to unlock the tags. Such procedures include inquiry and cooperation with the person or party that locked the tag, using a list of previously used passwords, brute force (e.g., attempting to unlock a tag by trial and error, perhaps over numerous retry cycles until the tag finally unlocks), or other cracking methods.

Certain embodiments perform secondary mechanical processing and/or cleaning procedures to recondition tags to conform with a product and/or customer specification. Cleaning procedures may include removal of residues, adhesives, wax, packing material, or other foreign objects. Certain cleaning methods may also use bleach, disinfectants, or boiling water to kill or remove biological contaminants.

Tags that have acrylate or a similar adhesive for attachment to a carton may be detached from corrugate using a suitable process. One such process is via thermal removal. Certain embodiments for thermal removal processes include use of cryogenic liquids or Dry Ice to cool the bonding adhesive and the surrounding area to temperatures well below the operating range of the adhesive. One embodiment uses direct thermal conduction from a cold or cryogenically cooled metal shoe that slides against or is otherwise placed in contact with the tag. Other embodiments may reduce the temperature of the tag's adhesive using cryocoolers, pulse tube refrigeration systems, multi-stage refrigeration systems, closed cycle refrigerator systems, Joule-Thomson coolers, thermoelectric coolers, heat exchangers, Gifford-McMahon coolers, carbon dioxide pellet blast systems, or other thermal transfer systems.

Certain packaging methods include tags that are attached to a continuous web of release liner. The release liner in some embodiments may be reused, having been recovered from customers rather than being discarded in landfills or waste paper recycling streams.

Tags may be shipped to customers in bulk quantity to minimize shipping and handling costs.

Step 59 involves converting OCC into pulp. Certain embodiments bale or rebale OCC for transportation to a distant location for repulping OCC into its constituent fibers and separate the reusable fibers from contaminants. Processed pulp may then be sent to a linerboard mill and further processed into new corrugated containers at step 51.

Inlays and printable “smart labels” (also referred to as “tags”) of the type shown in FIGS. 1, 2, and 3 are typically 140 to 250 micrometers thick, can be rolled onto a reel, and are designed to pass through a printer. Tags, inlays, and inlets of this type are designed to achieve very low cost targets—downward from 20 cents (in U.S. 2005 dollars). For many applications, this type of tag will optimally receive and transmit UHF signals. However, certain configurations, such as tagging corrugated cartons that contain metal and/or liquid suffer from poor RF performance. The metal or liquid may adversely affect the tag or inlay of the type shown in FIGS. 1, 2, and 3.

In some tag/inlay configurations for cartons that contain metal and/or liquid, the tag/inlay may be combined with a thick layer of material having a high dielectric constant and a metallic layer on the opposing side to shield the inlay from parasitic effects of nearby metal or liquid. The combination of the RF antenna, high dielectric material and metal layer create an RF radiating and conducting structure with a controlled impedance and radiation resistance, regardless of nearby metal or liquid. Industrial versions of such designs are referred to as metal mount RFID tags.

For general supply chain use, one configuration would be for inlays to be combined with a backing layer of RF absorbing material to reduce the effects of metal or liquid behind the tag. The RF absorbing material may, for example, include ferrite-based absorbers that are able to provide reflection reductions of over 10 dB in the UHF frequency range. Ferrites are a form of sintered iron and other metallic oxides having a cubic crystal structure. If the inlay is used as part of a transponder with a metal shield on the backside, then a thin flexible sheet of RF absorbing silicone or urethane having powdered iron pigmentation may be placed between the inlet and the metal shield. In this embodiment, RF is absorbed by canceling reflections with another reflection from the metal reflector on the back surface of the transponder. By adjusting the thickness and complex magnetic permeability of the medium, a condition of low reflection is achieved at the resonant frequency for angles near normal incidence. RF loss is induced throughout the quarter-wave thickness. In such a configuration, the inlay responds to incident radio waves, but receives no RF energy or detuning affects from the backside—that is, within the transport container. This response has both positive and negative effects. The negative effect is that no beneficial reflected signal can enter the tag from the backside, but the positive effect is that the metal or liquid does not create a parasitic capacitance with the RF antenna on the inlay.

Certain configurations for tags attached to cartons containing metal or liquid are battery-assisted RFID tags or wireless tags having thin-film batteries. Technological advances in battery design have enabled “paper thin” batteries to be part of an RFID tag and boost RF performance by powering the integrated circuit rather than using the illuminating RF field to exclusively do so. RF signals are backscattered to the RFID interrogator or wireless tag access point in a manner that is similar or identical to passive tags.

Certain wireless tag configurations may also be capable of carrying higher functionality devices that are capable of performing other functions in addition to automatic identification. For example, monitoring temperature, pressure, shock, vibration, biological agents, nuclear radiation, the presence of explosives or other molecules of interest, and global position are all possible using tags with a power source that is available when needed to make such measurements. Many of such wireless sensors would use a battery. Some may also use solar cells to power the tag during measurement and monitoring periods.

Certain other tags, sensors, or transponders having a higher level of functionality may include those that store records of interactions with RFID interrogators. Such tags may retain an audit trail of certain data exchanges and interrogations at read points. Data records may include information about time and place of interrogation, identity of interrogator, type of data exchanged, passwords used, protocols used, errors encountered, frequency bands used, and other such detailed information regarding any interrogation event.

In certain embodiments, the place an interrogation occurred may be encoded using GPS coordinates or some derivative thereof in order to fit into a minimum number of bits of data storage area in a transponder's memory. Other coding methods may be employed that would use less memory. Another method of encoding interrogator locations is to store a reference, index, or pointer into a table of known interrogation locations.

Certain transponder embodiments may have circuitry for monitoring long term health and viability of the transponder memory, battery, or other system elements that may be affected by aging. Such circuitry may be capable of reporting measurements via the transponder's air interface.

Inlays may also be converted into smart labels by attaching them to facestock. The facestock is the surface of the tag that can be printed. In one embodiment, labels and panels may be constructed from facestock material. Paper and plastic facestocks may be used with RFID-enabled labels. Metal foil, metallized plastics, metal filled plastic, or high UHF attenuation plastic facestocks are typically not used in RFID-enabled labels, except in specialized applications.

Paper facestock may be the lowest cost RFID tag structure, but it is the least environmentally resistant. UV-resistant plastic and plastic foam facestocks generally provide the best survivability in outdoor and rough service environments, and also tend to provide the best protection for the tag.

Certain panels, seals, and facestock that remain adhered to the corrugated carton after the transponder has been removed may be made from natural fibers but are resistant to degradation due to water, condensation, humidity, frost, and extremes of heat and cold. The constituent materials of such panels, seal, and facestock may be compatible with corrugated recycling and repulping processes.

Certain methods of wireless tag and smart label removal and recovery expose tags to extremes of hot or cold temperatures. Adhesives that bind tags to their associated containers may be formulated to fail at temperatures below −75 degrees Centigrade or above 100 degrees Centigrade. Tag removal processes involving extremes of heat or cold preferably do not result in damage to the wireless tag.

Seals, panels, or labels that cover the inlay or wireless tag are typically radiolucent to allow radio signals to pass freely through the material over a range of environmental conditions including extremes of heat and humidity. Panels that are used as a backing material for mounting transponders to transport containers, boxes, and shrink wrap may also be radiolucent, and do not interact with the electromagnetic fields that surround the antenna structure(s). Such backing material may also be compatible with certain high-speed packing processes such as hot melt adhesive application and other gluing methods. Seals, panels, backing material (i.e. underlayments), and labels may be made of paper or plastic.

Each of the embodiments illustrated in FIGS. 1, 2, 3, 6, 7, 15, 16, 17, 18, 25, 27, and 29 may accommodate tags having a range of thicknesses from a few thousandths of an inch to a significant fraction of an inch. Certain embodiments may accommodate a wide range of transponder lengths, widths, thicknesses, and shapes and therefore a diversity of transponder types that may include inlays backed or surrounded by a thick layer of dielectric material. Certain transponder embodiments are comprised of a tag or inlay wrapped or surrounded by one or more layers of corrugated linerboard or cardboard to protect the tag from damage or detuning. One such transponder is created by rolling a flat sheet of corrugate into a spiral to create a cylinder with a tag in the center. Such a construct becomes particularly economical when using recycled tags and corrugates. Certain embodiments may also have a metallic underlay, an inlay over RF absorbing material, and may further include semi-passive tags with batteries or wireless sensors with advanced features. Some advanced tag features may include encryption, a battery, automatic antenna self-tuning features, self-compensation for variations in localized capacitance or dielectric constant, temperature sensing, detection of thermal or cryogenic tag detachment events, data logging, humidity sensing, GPS location logging, sound monitoring, pressure monitoring, shock and vibration monitoring, or sensing of other environmental parameters.

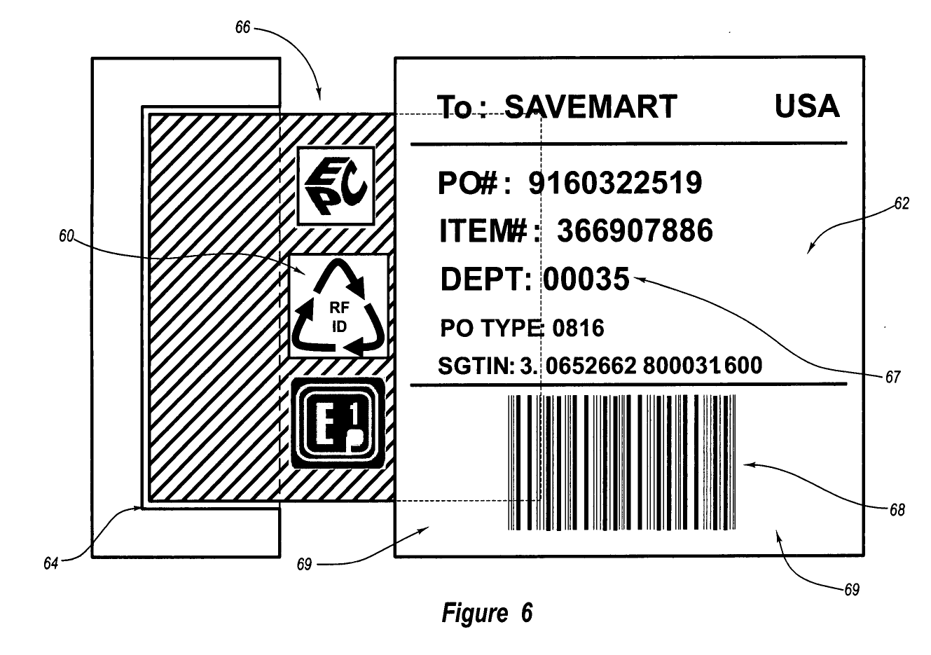

FIG. 6 depicts a dual dipole tag 60 that is retained to a transport carton by both a printed 62 and an unprinted 64 seal. The slit 66 in the seal may be either virtually nonexistent or a wide portion of the width of transponder 60. Certain embodiments have a slit that is off-center or asymmetric to afford ample space on the printed label for conventional carton labeling in conformance with industry standards, as shown in FIG. 6. The standard printing usually includes human-readable text 67 and machine-readable bar code symbol 68. The printed 62 and unprinted 64 seal parts are attached to the transport container wall only in selected regions 69 by bonding with an adhesive. Transponder 60 may also be bonded to printed 62 and unprinted 64 seals with an adhesive.

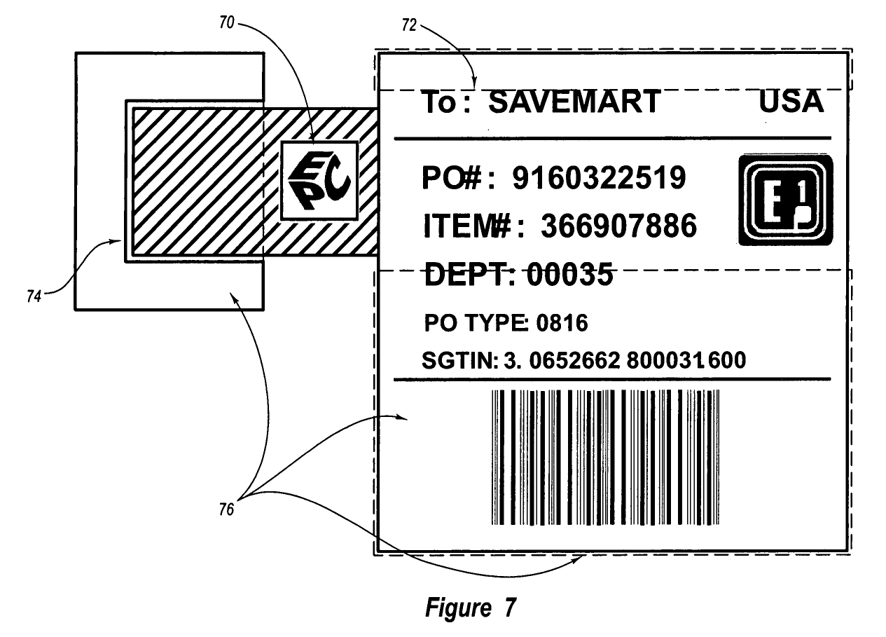

FIG. 7 depicts a single dipole tag 70 that is retained in a manner similar to the dual dipole tag 60 illustrated in FIG. 6. Tag 70 is also retained to a transport carton by both a printed seal 72 and an unprinted seal 74. There is no requirement for seal piece 74 to be smaller than seal piece 72. They are illustrated as such but can be of various sizes and shapes as may be required by the specific tagging application. Many commercial applications seek to minimize label sizes so that underlying graphics and brand marks are not occluded. In certain embodiments, the printed 72 and unprinted 74 seal parts are attached to the transport container wall using an adhesive only in selected regions 76. In certain other embodiments, regions 76 bond with a container wall and the remaining regions are for the most part bonded to a outward face of transponder 70.

The tag and seal configurations shown in FIGS. 6 and 7 can be applied to a transport container using automated tooling.

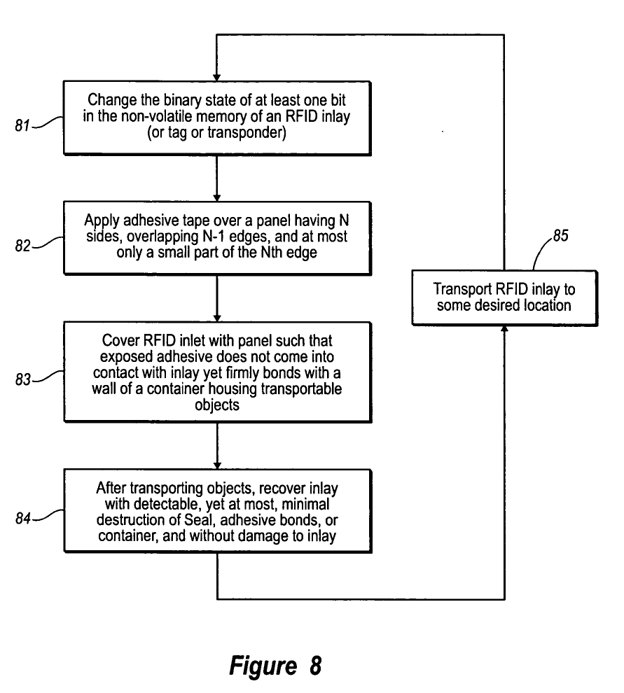

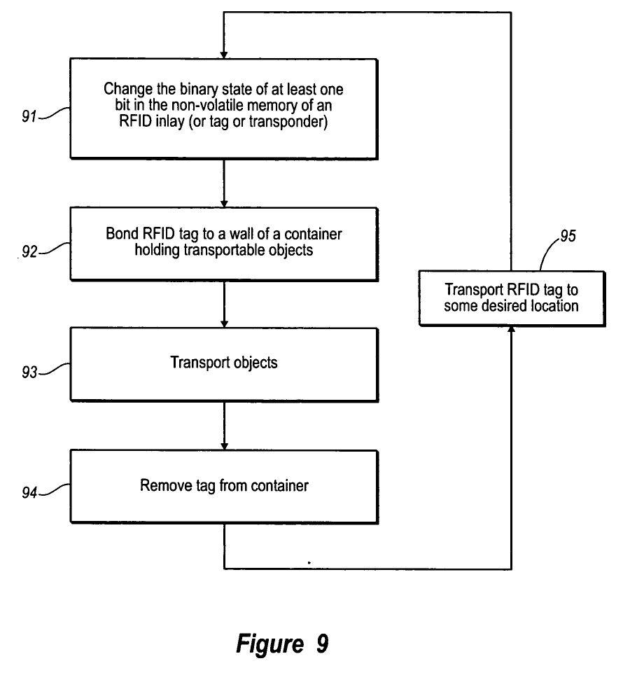

Referring to FIGS. 8 and 9, certain methods are disclosed by which RFID tags, inlays, or wireless sensors are attached to a transport container, such as a corrugated carton or shrink wrap. In certain embodiments, the three primary components may include: an inlay (or transponder, tag, or wireless sensor), a non-adhesive panel, and a layer of adhesive tape.

The inlay may or may not be converted into a label, but there is no need for anything more than a chip bonded to an antenna, formed on a plastic substrate. A bare inlay may be protected from electrostatic discharge (“ESD”) damage by an ESD dissipative coating and/or by ESD dissipative or electrically conductive material handling containers. In certain embodiments, the inlay may be constructed on more durable substrates that can tolerate rough handling, bending, and abuse. This more durable construction may be accomplished by merely constructing the inlay on thicker sheets of die cut plastic, or, alternatively, adhering one or more adhesive-backed inlays onto a second and more durable substrate to create a transponder.

In certain embodiments, a non-adhesive panel may be used to completely cover the transponder, tag, wireless sensor, and/or inlay so that the sensor, transponder, tag, or inlay never comes into direct contact with any adhesives that would have to be deactivated or removed before subsequent reuse of the transponder, sensor, or inlay. In other words, it may be desirable to never allow the transponder, sensor, or inlay to come into contact with a sticky material, and itself become sticky, than to later incur effort or expense to deactivate the adhesive bonds, or remove sticky adhesive residues. Pursuant to that, in certain embodiments, a permanent adhesive bond is formed between the wireless sensor and a portion of one face of a non-adhesive panel with the intent that the bond will not be deactivated in preparation for any subsequent cycles of reuse. In other words, rather than incur the effort or expense of deactivating an adhesive bond between the wireless sensor and the panel, the panel becomes an integral part of the wireless sensor on all future reuse cycles. The dimensions of the panel need not be much larger than the transponder, sensor, or inlay; it may only be necessary to account for manufacturing tolerances in the placement of the transponder, sensor, or inlay and the panel relative to each other. The panel can be made of various cellulose fiber materials such as paper, or various plastic materials, preferably materials that will not absorb radio frequencies within the range of frequencies used by the transponder, tag, sensor, or inlay. It may also be desirable to select the panel materials such that they do not cause corrosion of the inlay or in any way hamper its functionality.

A layer of clear, translucent, or opaque adhesive-backed film or tape may be used to attach the panel and the transponder, wireless sensor, or inlay to the box, bottle, jug, transport container, or shrink wrap. The tape may be any thin, low cost, flexible material with a self adhesive backing. A conventional packing tape is representative of the material that may be used for this method of attachment. The tape may be formed into various shapes to achieve the requirements of this method. Certain embodiments may use tape that is preprinted with certain logos, marks, symbols, bar codes, colors, and designs. Certain preferred locations for taping or attaching a wireless tag include the interior of a carton, including portions of the flaps and inner walls, in order to provide a greater degree of mechanical and ESD protection for the tag.

FIG. 8 illustrates a method of inlay recycling. The first step 81 is to read the transponder, wireless sensor, tag or inlay, possibly monitoring parameters such as activation energy, backscatter signal strength, sensor performance, and other indications of the quality of the tag. Any tag or sensor that does not meet certain minimum performance criteria may then be discarded. Good tags or sensors may be programmed with new information relating to the object that it is being associated with. That information may be stored in non-volatile memory within the RFID inlay. Tag programming may also occur during, after, or between the second step 82 and third step 83.

The second step 82 is to apply the adhesive tape over the panel. This step may be performed in such a way that one edge is left with little or no adhesive tape overlapping it. For certain embodiments, the adhesive tape may be no larger than is necessary to attach a transponder and panel to a carton. Adequate coverage of three edges may be preferred for some applications over adequate coverage of only two edges and having two remaining edges with insufficient tape to adequately protect them from snagging, or worse causing premature transponder removal. In certain embodiments, the adhesive tape may be printed with information.

The third step 83 is to completely cover the transponder, tag, wireless sensor, or inlet with the combined panel and adhesive tape layer. This step may be performed such that exposed adhesive surfaces do not come into direct contact with the inlet or sensor. The overlapped edges of tape may be bonded firmly and directly with the transport container walls. The container may, for example, be a corrugated carton for use in shipping cases of goods to a retail store, pharmacy, doctor's office, or military exchange. The walls at which the bonding occurs may be internal walls or external walls, and may be on any of the six sides of a typical shipping container, including any flaps or cavities. The adhesive may be selected and applied such that it creates a strong and permanent bond with the container over a certain practical range of operating temperatures.

The fourth step 84 is to remove the transponder, tag, wireless sensor, or inlay from the transport container after it has been used. Step 84 tag removal may be a manual operation at the final point of use, or, alternatively, by an automated process at a preferred location into or within a waste stream recycling process. For corrugated transport containers, one downstream tag recovery method involves salvaging tags and wireless sensors within or immediately preceding an OCC repulping process. In certain embodiments, the tag or inlay may not be completely separated from all parts of the transport container that it was attached to. In certain embodiments, parts of the old tag and container become part of the recovered reusable tag.

The fifth step 85 is to transport the transponder, tag, wireless sensor, or inlay to another location for subsequent reuse, beginning at, for example, any of the steps 81, 91, 101, 191, or 281 from FIGS. 8, 9, 10, 19, and 29, respectively, as may be appropriate to the type of business process, transponder, wireless sensor, attachment method, and transport container.

Referring to FIG. 9, the first step 91 is to read the transponder, wireless sensor, tag or inlay, possibly monitoring parameters such as activation energy, backscatter signal strength, sensor performance, and other indications of the quality of the tag. Any tag or sensor that does not meet certain minimum performance criteria may be discarded. Good tags or sensors may be programmed with new information relating to the object that it is being associated with. That information may be stored in non-volatile memory within the RFID inlay. Tag programming may also occur during, after, or between the second step 92 and third step 93.

The second step 92 is to firmly bond or attach an RFID tag to a transport container. The container may, for example, be a corrugated carton for use in shipping cases of goods to a retail store, pharmacy, doctor's office, or military exchange. The walls at which the bonding occurs may be internal walls or external walls, and may be on any of the six sides of a typical shipping container. The adhesive may be selected and applied such that it creates a strong and permanent bond with the container over a certain practical range of operating temperatures. Certain embodiments use adhesive tape or packing tape to adhere RFID tags, transponders, wireless sensors, or inlays to transport containers such as corrugated cartons. Some such embodiments use pre-printed adhesive tape.

The third step 93 is to transport the tagged container of objects to another location. In certain embodiments, the tag is interrogated and data derived therefrom is used to track the objects.

The fourth step 94 is to remove the transponder, tag, wireless sensor, or inlay from the transport container after it has been used. Step 94 tag removal may be a manual operation at the final point of use, or, alternatively, by an automated process at a preferred location into or within a waste stream recycling process. For corrugated transport containers, one downstream tag recovery method is to salvage tags and wireless sensors within or immediately preceding an OCC repulping process. In certain embodiments, the inlay may not be completely separated from all parts of the transport container that it was attached to. In some such embodiments, parts of the old tag and container become part of the recovered reusable tag.

The fifth step 95 is to transport the transponder, tag, wireless sensor, or inlay to another location for subsequent reuse beginning at any of the steps 81, 91, 101, 191, or 281 from FIGS. 8, 9, 10, 19, and 29, respectively, as may be appropriate to the type of business process, transponder, wireless sensor, attachment method, and transport container.

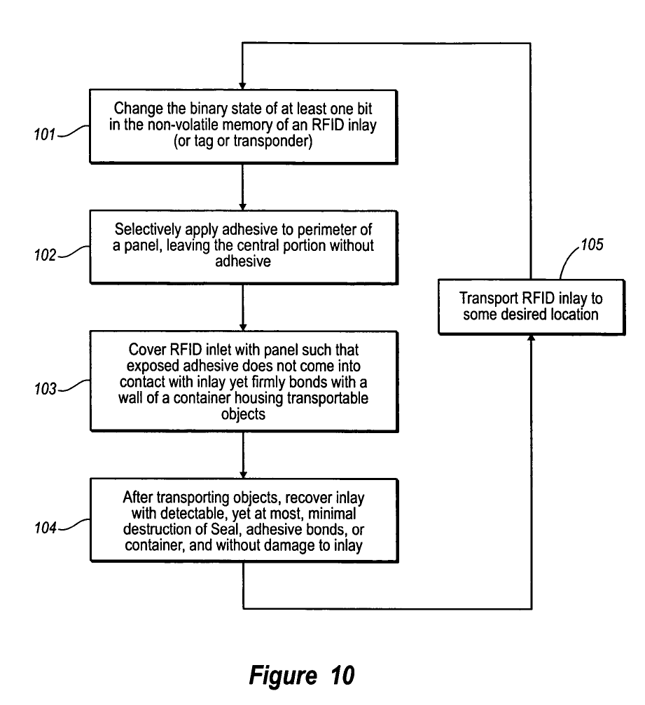

Referring to FIG. 10, a flowchart is presented for a method of attaching transponders, tags, wireless sensors, or inlays to transport containers based on selective application of adhesive just prior to time of transponder or sensor attachment. Some forms of adhesive that may be applied are hot glue, UV cured, or pressure sensitive adhesives that are activated on contact. In some embodiments, the adhesive may be selectively applied around the perimeter of the transponder, tag, or wireless sensor. An alternative method is to apply adhesive anywhere onto a surface of the transponder body that is not adversely affected by the adhesive, its application, or its subsequent removal.

The first step 101 is to read the transponder, tag, wireless sensor, or inlay, possibly monitoring parameters such as activation energy, backscatter signal strength, sensor performance and other indications of the quality of the tag or sensor. Any tag that does not meet certain minimum performance criteria may be discarded. Good wireless tags may then be programmed with new information relating to the object that it is being associated with. That information may be stored in non-volatile memory within the RFID inlay. Wireless tag programming may also occur during, after, or between the second step 102 and third step 103.

The second step 102 is to selectively apply the adhesive around, for example, the perimeter of the panel, seal, carrier, encapsulated transponder, or wireless sensor, in some cases without allowing any adhesive to contact a region in the center of the panel, seal, carrier, encapsulated transponder, or wireless sensor. The applied perimeter may be greater than or equal to the size and shape of any exposed tag or inlay. In some embodiments, there may also be a perimeter clearance space of, for example, at least twice the tag or inlay thickness on all edges. If there is no exposed inlay, then adhesive may be applied in a selective manner over the entire surface that is to be attached to a transport container.

Certain methods of panel, seal, carrier, pocket, or direct transponder/sensor attachment and detachment use reversible adhesives that may be applied around their perimeter. The chemical linkages that form the bonds of such adhesives are broken by an external force such as heat conduction into or out of the adhesive, or electricity when the wireless sensor is to be harvested for reuse.

The third step 103 is to adhere the transponder, tag, wireless sensor, or inlay associated with the adhesive-faced panel, seal, or carrier to a wall of a transport container, in some cases such that the exposed adhesive does not come into contact with the inlay/sensor.

The container may, for example, be a corrugated carton for use in shipping cases of goods to a retail store, pharmacy, doctor's office, or military exchange. The walls at which the bonding occurs may be internal walls or external walls (for example, on either the inner linerboard or the outer linerboard of a corrugated carton), and may be on any of the six sides of a typical shipping container. In some cases, the adhesive may be used to create a strong and permanent bond with the container.

The fourth step 104 is to safely remove the transponder, tag, wireless sensor, or inlay from transport container, preferably without damaging the RFID inlay or wireless sensor.

Step 104 may be performed at a point in the supply chain or OCC recycling process where the cost of removal is relatively low, and the value of the recovered transponder, tag, or wireless sensor is at or near its peak value. Step 104 will typically not be performed when substantial value would otherwise be derived from its continued attachment to the object that it was commissioned to identify, track, or monitor. Step 104 may be performed on certain preferred embodiments disclosed herein and using certain preferred automated or semi-automated tag/sensor removal, recovery, or salvage machinery.

The fifth step 105 is to transport the transponder, tag, wireless sensor, or inlay to another location for subsequent reuse by restarting at any of the steps 81, 91, 101, 191, or 281 from FIGS. 8, 9, 10, 19, and 29, respectively, as may be appropriate to the type of business process, transponder, wireless sensor, attachment method, and transport container.

The flow chart of FIG. 11 illustrates a method for sorting recyclable materials and removing and reusing wireless tags from certain biodegradable or recyclable containers, such as corrugated cartons, glass bottles, metal cans, or plastic containers.

Step 119a takes place where the goods are manufactured. Step 119b takes place at the point at which goods are packaged into containers such as item level, inner pack, case level, trade unit, pallet, and transport units. A tag is commissioned for use, which may involve programming the tag, physically attaching the tag to an object or recyclable container, and/or associating tag data with the object currently attached or soon to be attached thereto. Records may be made in suitable databases in order to logically bind the tag with the object, and to share that information with other computer databases, trading partners, or regulatory authorities. Certain attachment methods and embodiments for seals, pockets, carriers, inlays, and tags are disclosed herein.

In step 110, the wireless tag moves as it is attached to a container, possibly moving through supply chains and/or channels of commerce and replenishment. It may be interrogated by authorized RFID readers, access points, or other wireless tags on a peer-to-peer basis. The tag and the recyclable object or container to which the tag is attached may be transported to one or more desired locations, possibly being interrogated at various times and places preferably only by authorized devices and information systems.

In step 111a, wireless tags and containers are transported to and received by certain tag recycling or reclamation equipment.

In step 111b, tags are interrogated to determine which container recycling and/or material handling process should be used. The tag may communicate certain preferred tag removal information or certain identifier codes that enable tag removal information to be acquired from one or more databases.

Steps 112a through 112d are executed in any preferred sequence that fits with the particular recycle waste stream management application. In each of steps 112a through 112d, information from the tag may be used to determine what the tag is attached to and how the container should be recycled. Other such information may include: how the tag is attached, the type of tag attached, and the preferred process for removing the tag from its associated container.

Steps 113a through 113d utilize certain equipment to remove the wireless tag from the recyclable or biodegradable container, preferably without damaging the tag. Certain embodiments for executing such a tag removal are illustrated and described herein. There are various systems/methods/parameters for removal of a tag from corrugated cartons, glass jars and bottles, metal cans, or plastic jugs or bottles. In certain systems, recyclable containers may be received in bulk quantities, while others may be optimized for receiving recyclable containers in single piece units. Certain embodiments that receive recyclable containers in bulk quantities may also implement one or more mechanisms to feed recyclable or biodegradable containers one-at-a-time into the subsequent processing steps.

In steps 114a through 114d, the recyclable or biodegradable containers to which the tag was attached are processed according to preferred methods for glass, plastic, metal, and fiber waste streams, respectively. Those materials may then be used as feedstock for the relevant recyclable container manufacturing steps 117a through 117d.

In steps 115a through 115d, the detached wireless tag is tested, graded, and sorted. Parameters for testing may include identification of the tag manufacturer, type, version, age, shipper, minimum activation energy, sensor performance, backscatter signal strength, angular sensitivity, read range, number or percentage of successful reads, battery life, or certain other preferred metrics.

Certain packaging methods may utilize tags that are attached to a continuous web of release liner. In some methods, recovered inlays are encapsulated or used as a component to create a tag or transponder for subsequent reuse. Tags and the release liner may be wound together onto a reel or stacked into a z-fold. Certain reels have a cylindrical core, and are loaded into a cartridge or a box. Z-folded release liner is preferably loaded into a magazine or cartridge.

Certain methods for RFID tag attachment and handling prior to application may use pressure sensitive adhesive and release liners. For those types of tags, the release liner may be configured to be reusable, having been recovered from customers rather than being discarded in landfills or waste paper recycling streams. Release liners may be manufactured in step 118a or reused in step 118b. In step 118c, they are transported in bulk quantities to tag recovery and reprocessing sites. Steps 118a, 118b, and 118c are typically not used for transponders that are recovered and reused without reapplied pressure sensitive adhesives. Of course, some tag embodiments do not use any release liners at all.

In step 116a, tags are auctioned, sold, bought, traded, rented, or otherwise matched with a trading partner in a tag trading marketplace. Such a marketplace may be, for example, conducted by computer hardware and software, possibly using the Internet as a means to convey trading information.

In step 116b, tags are shipped to customers in bulk quantity to minimize shipping and handling costs. Such tags may then be used in the manufacturing and packaging operations of step 119b.

Certain methods of commissioning RFID tags, transponders, or wireless sensors involve applying them to a carton or other shipping container using automated applicators. Some embodiments of recovered and reprocessed RFID transponders have no exposed adhesive. The reprocessed transponders may be handled and transported in a magazine. In certain embodiments, the magazine may house a stack of RFID transponders, tags, or inlays.

As time goes by, more types, varieties, and classes of electronic tags will enter the marketplace, and upon implementation of the systems and methods disclosed herein, tag recyclers may seek a system to recycle those tags to create a market for low cost used tags. The methods and apparatus disclosed herein enable a market for economically reconditioning, reselling, and reusing wireless sensors. As with any market for sale of used goods, specific information about those goods needs to be made available to the buyer. For example, persons seeking to buy a used car over the Internet have a rich set of detailed information regarding the make, model, style, color, features, age, mileage, and condition of the car. As the used tag market develops, similar information will also become important to the functioning of a thriving market for used RFID tags.

Certain embodiments are directed to methods of identifying the model, type, and manufacturer of recycled tags from the masses of tags that will be recovered in such places as retail stores, military bases, parcel delivery services, pharmacies, and doctor's offices. Such identification is possible by several means, including visual identification by appearance, by printed indicia, or from data retrieved from the RFID tags' memories, as described and set forth herein. Transponders will respond to data retrieval efforts in various ways. Some tags will not respond at all because they are either damaged or not designed to perform certain functions. A second class of response is a positive, but weak response where signal coupling is compromised by degradation of the tag's performance due to wear or damage. The third possible response is a strong positive response to data retrieval operations on the tag. It is this type of tag that may be provided for sale as a reused tag, or for reuse under a rental contract.

It is recognized that not all RFID tags carry vendor identification in their nonvolatile memories. For those that do, or can be configured to do so, real-time sorting can be achieved in a straight forward manner of reading that information, making real-time automated sort decisions, and diverting each transponder to its appropriate destination or storage area. Automated sorting of used wireless tags is most easily accomplished on a conveyor line where tags have been singulated for identification and routing through a sorter, such as a shoe sorter that automatically diverts items to different conveyance routes.

For tags that cannot or simply do not carry information about themselves, one method for sorting involves using the information that is stored on the tag as a reference to look up information about the tag's own descriptive data.

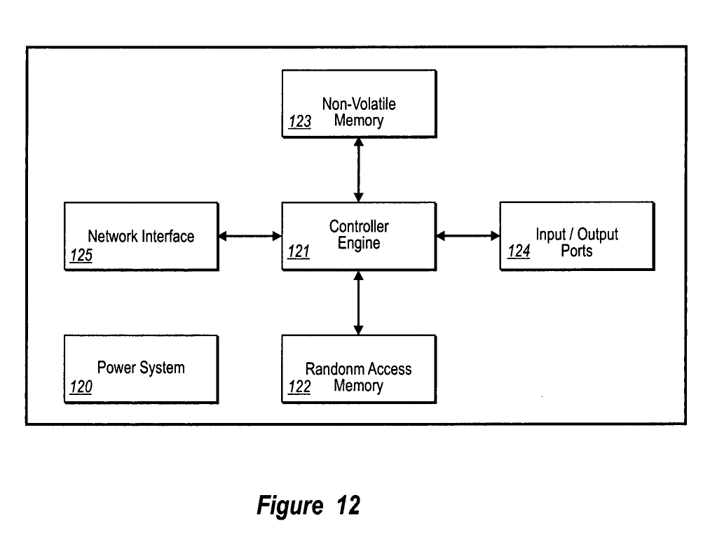

A Tag Sort Controller is disclosed and illustrated in the system block diagram of FIG. 12 and another is shown as Tag Sorter 317 in the embodiment of FIG. 31. Regardless of which type of data is available for tag sorting, this apparatus may be used to process that information and make real-time signals and commands to automated conveyance devices and the means to divert tags to their designated storage locations.

In FIG. 12, the depicted Tag Sort Controller has a power system 120, a controller engine 121, a random access memory 122, a non-volatile memory 123, inputs & outputs 124, a network connection 125, and an IP address. The power system 120 distributes power to the various other components of the Tag Sort Controller and assures that minor power feed disturbances do not affect its operation. The controller engine 121 may be configured to use input from RFID interrogators, communicating to them through either the network interface 125 or a parallel or serial port 124. Tag data from various tag fields may be processed by the controller and commands and/or output signals may be generated to redirect the flow of tags in a material handling system. The network connection 125 may also be used to receive updates for programs and data stored in non-volatile memory 123. Random access memory may be used for all general data processing, message processing, and program execution.

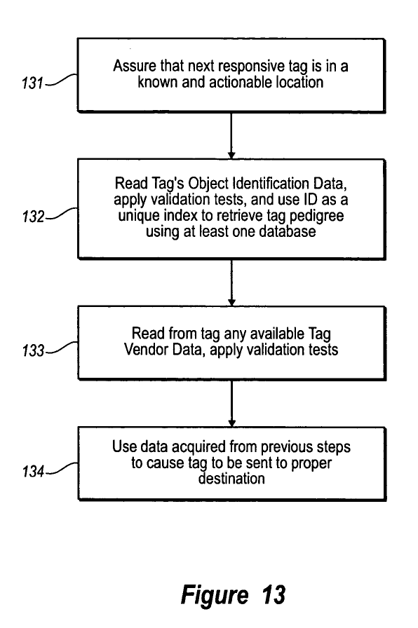

FIG. 13 is a flow chart illustrating a method for a Tag Sort Controller apparatus to receive information from one or more RFID interrogators and controlling where they should be diverted to by material handling equipment.

The first step 131 is to assure that, as each RFID tag enters a sorting area, it does so in such a manner that the system is capable of reading each and every functioning RFID tag and unambiguously identifying its physical location. Automated sorting of used wireless tags is often accomplished on conveyor lines or sortation equipment by singulating such that there is no more than one object or tag in the interrogation zone at any one time. Other methods may be employed, such as using techniques to increase the resolution of the interrogating field in order to tolerate high entropy tag flows. A corresponding tag diversion apparatus must be employed that can properly divert sorted tags to their proper destination or storage location. In any case, the first step 131 of the method is to assure that a responsive tag is in a known and actionable location that is appropriate to the interrogation and diverting technology employed.

In the second step 132, the RFID interrogator(s) may be capable of energizing, controlling, and communicating using a variety of air interface protocols. The tag's Object Identification Data may be read and stored in the Tag Sort Controller's random access memory 122. Since there should be no two RFID tags carrying the same information and referring to different data sets, it is possible to use the Object Identification Data as an index into a database. Model, class, type, and manufacturer information can be stored in the database and associated with the unique object identification data payload of that tag. In certain embodiments, manufacturers provide information that includes machine-readable descriptive information for the purpose of locating the precise position of the RFID tag on that manufacturer's transport container. Certain embodiments use a system of coordinates that are referenced to identifiable features on the transport container. In certain embodiments, manufacturer information includes details of the major axis along which corrugated fluting is aligned relative to the wireless sensor or its associated label. Manufacturer information may be retrieved from at least one database. In one embodiment, one or more databases reside in the Tag Sort Controller, which may be located inside of non-volatile memory 123.

In one embodiment, RFID transponders, tags, and wireless sensors may be subjected to a controlled interrogation field to read and grade each transponder and wireless sensor, possibly monitoring parameters such as activation energy, sensor performance, backscatter signal strength, read range, number or percentage of successful reads, and other indications of the quality of the tag or wireless sensor.

In one embodiment, the Object Identification Data that is read in the second step 132 may be used to record, in random access memory 122, for example, the instance of a tag having certain identification codes that signify the identity of the manufacturer of the goods, the distributor of those goods, and/or the logistics provider of the goods in the transport container. The number of such occurrences is representative of how many of that supplier's tags arrived at a particular Tag Sort Controller. This information may be periodically transmitted out through the network interface 125 to be recorded in databases that track the number of tags that are successfully processed by Tag Sort Controllers in multiple locations. An aggregation of that information may be used in comparison to multiple suppliers to determine an equitable allocation of used tags, transponders, inlets, and inlays. In some systems, the more reusable tags that a particular supplier or shipper provides to its recipients, the greater the number of reusable tags that supplier or shipper should be allowed to receive in the future. As demand for used tags grows, so should the practice of measuring suppliers' and shippers' contribution and consumption of tags to and from global inventories of reusable tags.

The third step 133 is for certain embodiments to assess additional transponder information. In this optional step, one or more interrogators can read any available Tag Vendor Data. One method of doing so is to query blocks of memory that are designated for such data for known types of tags matching certain air interface protocols. For certain embodiments, Tag Vendor Data may not be rewritable. In certain embodiments, Tag Vendor Data may include serialized numbering to create permanent identification that is uniquely identifiable and preferably difficult to counterfeit. If this information is not available, then subsequent steps will depend only on the Object Identification Data. If the Object Identification Data is not available from a wireless sensor or for some reason not usable, then subsequent steps will depend only on the Tag Vendor Data. If neither the Object Identification Data nor the Tag Vendor Data are available and usable, then the tag, transponder, or wireless sensor may, in some cases, be discarded and not reused.

The fourth step 134 is to use the information acquired from the tag and databases to determine where to send that particular tag by generating commands or signals from the inputs/outputs 124 or the network interface 125. That determination may be at least partly made after subjecting some or all of the data read from the tag to a set of tests that will prove the validity of the data and/or data format, and, if possible, the authenticity of the stored data. That determination is, in certain embodiments, also made by the results of tag testing to verify that the wireless sensors are in conformance with certain applicable tag standards. One method of determining the authenticity of the tag data is to determine if the data was stored and locked, preferably using a secure password. If a password was used, and if that password to enable writing data to the tag has not been compromised or in any way been obtained by unauthorized parties, then the data stored on the tag must have been written by an authorized password holder. Secure use of passwords for reading and/or writing certain data will help to start and sustain an efficient and trusted market for sale of used RFID tags at a competitive price.

In many cases, the Object Identification Data that is written to the tags is done so at or around the same time that the tag or wireless sensor is commissioned (i.e., mated with a seal or adhesive and attached to a transport container as disclosed herein).

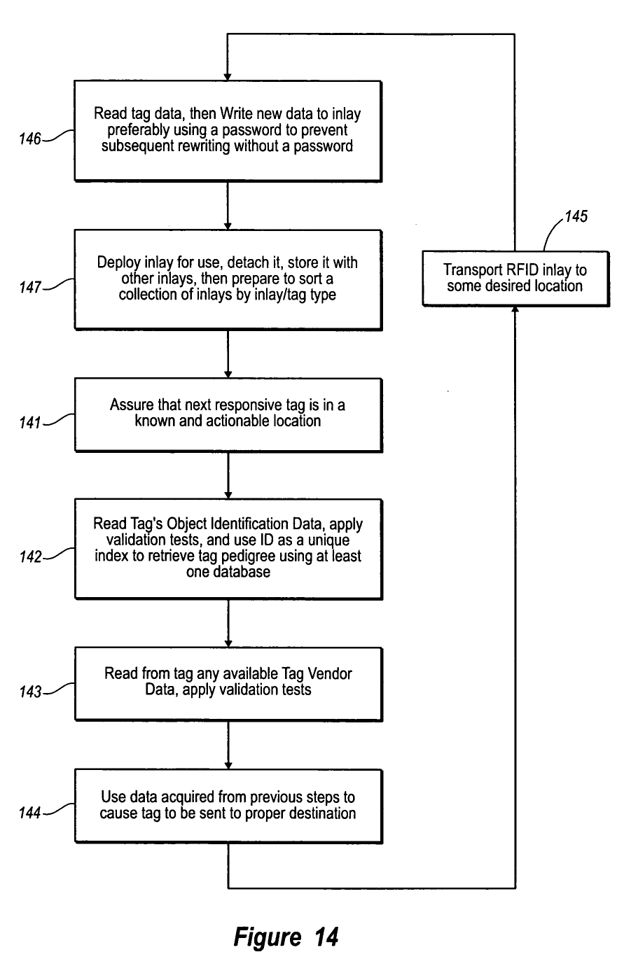

The flowchart in FIG. 14 is derived from the method and related flowchart shown in FIG. 13. The steps 141-144 correspond with steps 131-134 in FIG. 13. Step 145 corresponds to any of steps 85, 95, 105, 199r, 235, 285, or 305 in FIGS. 8, 9, 10, 19, 23, 28, and 30, respectively, and refers to a process of redistributing transponders, tags, inlets, or inlays back to a point of preparation or attachment, such as at a factory, packing plant, distribution center, or third party logistics provider. There are a variety of financial mechanisms that may be associated with steps 85, 95, 105, 199r, 235, 285, or 305 including, but not limited to: refunding all or part of an eWaste fee or tax; donation of tags and transponders to a non-profit organization or another third party; and rental, purchase, or exercising rights under a fractional ownership program. Any of the foregoing may be performed by mandate, through internal operations of a government, the military, a company, or a group of trading partners. Ownership, title transfer, or transfer of certain rights and/or contractual responsibilities pertaining to possession, data reading, or data writing may be established and exercised at appropriate times and places in the methods disclosed herein. One method involves purchasing, or otherwise receiving title to, or donations of, used transponders and tags, followed by, for example, performing any of the following steps on the transponders/tags: remanufacturing, testing, sorting, grading, reconditioning, cleaning, sanitizing, stacking, loading into magazines, loading into packets, pockets, or pouches, and/or rolling onto a reel. This suite of value-added steps may then be followed by steps that include distribution, transport, sale, allocation to preferred customers, submittal of an invoice, and/or customer purchase of value-added transponders and tags.

The total number of reusable tags Pu (pool of all used tags) that are available may be represented by the following equation
Pu=Pr*Rr*Yr
where:
Pr=pool of reusable tags shipped
Rr=recovery rate (percentage)
Yr=yield rate (percentage) of tag recovery

Step 146 is a step of reading any existing tag data, storing and processing it, and writing new tag data to a tag using, for example, a secure method of commanding an RFID interrogator to lock multiple fields of one or more tags, such as with a password. The password may be fixed or variable, but will typically be secure from view by unauthorized persons or computing equipment. A method for managing multiple passwords is to use publicly readable data fields from the tag to generate an index into a secure table of passwords. That index can be used to fetch the appropriate password for that data instance. Embodiments of this method require that the same data always resolve to the same index value, thereby pointing to the same password lookup. The maximum size of the table is limited by the range of unique combinations that can be generated for an index, or the practical size limits for a database that can be securely stored at or near the point where passwords are used to write data to the tags in step 146. This security measure will help to assure that all data written to the tag is done so by a trusted party, and can be used reliably for performing various data-driven functions.

Other embodiments may use a secret algorithm to generate a password from certain tag data. This method can optionally be combined with an indirect database lookup method described above.

In step 146 of the method shown in FIG. 14, any tags that already had data encoded into certain fields are recorded in a database as having been used (i.e., a used tag). Similarly, any tags that did not have data encoded into certain fields are recorded in that database as having been “not used”—or new tags. The level of confidence in those observations may also be recorded in that database by indicating if the tag was locked in such a way that the data could not be altered, except in the case of a lock mechanism that allows unlocking using a secret password, in which case the trustworthiness of the password holders may be assessed by some additional method. Therefore, the number of used tags and the number of new tags can be recorded and known. This information may be used to determine suppliers' and shippers' contribution and consumption of both new and used tags. One method for allocating shipments of used tags to certain suppliers and shippers is based on a balance of tags consumed with tags contributed to global pools of reusable RFID transponders, tags, inlets, and inlays according to methods disclosed herein.

Step 147 refers to the process of actually using the RFID tag to identify objects that are being transported to a destination. The process may involve multiple transfers along a chain of custody until the transport container has reached its final destination, at which point the tag may be safely removed from the transport container using either manual or automated methods. Having done so, the tag may be placed into a vessel or container that is designed to accumulate tags.

Alternative methods may be employed for inserting the inlay, inlet, tag, or transponder within the layers of the corrugate. The tags may be inserted between the inner linerboard and the outer linerboard, in the region normally occupied by the corrugated medium. Some implementations of this method may require one or more incisions in the linerboard, and multiple incisions within the corrugated medium. Embodiments of a shuttle are disclosed that provide an automated method for inserting the transponder into the corrugate by creating and entering through an incision in the outer linerboard.

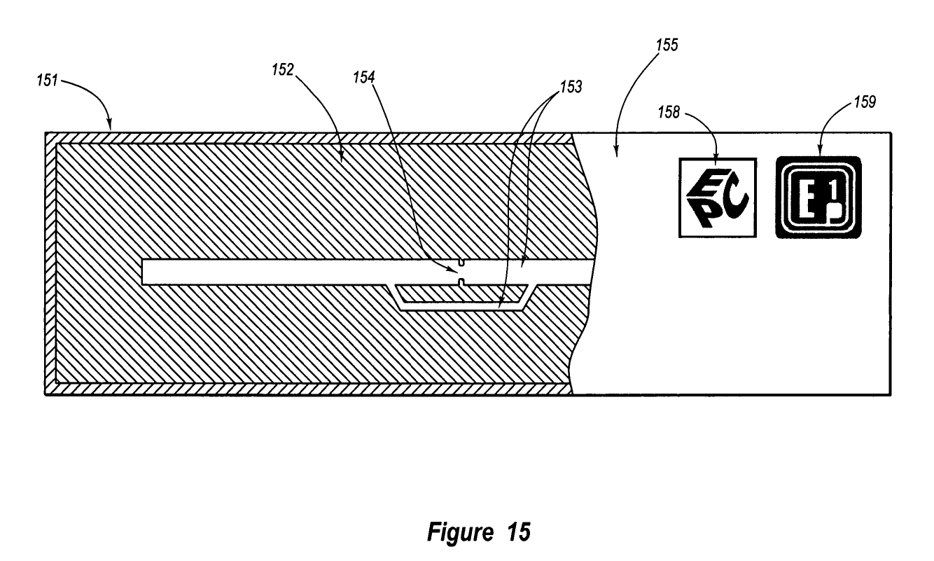

FIG. 15 illustrates a transponder embodiment that uses microstrip antenna structures 153 constructed on a substrate 151, or in certain embodiments on an intermediate substrate 152. Certain embodiments of substrate 151 may be constructed from or reinforced by corrugated Kraft paper, paperboard, or some other cellulose-based material and may provide a firm structure. In certain embodiments, the structural part of substrate 151 may be substantially larger than the portion of substrate 151 that provides immediate support of microstrip antenna structures 153. In certain embodiments, the structural part of substrate 151 may be formed into three-dimensional shapes. In certain other embodiments, the structural part of substrate 151 may be planar. In certain embodiments, substrate 151 is planar until after it is transported to a preferred location for commissioning in a subsequent use. In certain embodiments, planar substrate 151 is formed into a preferred three-dimensional shape prior to a commissioning step. The three-dimensional shape in some embodiments may be a polyhedron, and in some of these embodiments the polyhedron may be a hexahedron. In some embodiments, a preferred three-dimensional shape may be, for example, a long three-sided prism, a long four-sided rectangular tube, a cylindrical tube, a multi-layer rod with wireless sensor chip 154 embedded at the core, or a variety of other shapes and sizes that provide a range of preferred properties.

A protective layer 155 is shown (in a diagrammatic cut-away view) in FIG. 15 covering the microstrip antenna 151. Protective layer 155 may be thin and in certain embodiments may include a printed layer with barcode and/or human readable information. In certain embodiments, the information printed on the printed layer may be relevant to object identification data stored in the non-volatile memory of wireless sensor chip 154. In certain other embodiments, the printed information on protective layer 155 need not be relevant to object identification data that is stored in RFID chip 154. In certain embodiments, RFID or wireless sensor chip 154 is reprogrammed or rewritten with new information that does not relate to the printed information on protective layer 155. In certain embodiments, obsolete printed information on protective layer 155 may be covered by a thin covering layer in preparation for being reused. In certain embodiments, the thin covering layer may be an opaque material such as packing tape. In certain embodiments, the covering layer may be preprinted with certain identification that may include the EPCglobal seal 158 and/or an AIM RFID Mark 159, or other printed information.

Many consumer goods are packaged into corrugated cartons that are not fully enclosed by corrugated walls. One method for sealing goods into an open tray or carton is to stretch a thermoplastic film around the goods and the carton and shrink the thermoplastic film by subjecting it to elevated temperatures. Heat causes the film to shrink tightly around the goods and hold them firmly to the carton or tray. Methods for placing a transponder into a carton may include transponder placement either before or after the case is wrapped in thermoplastic film.

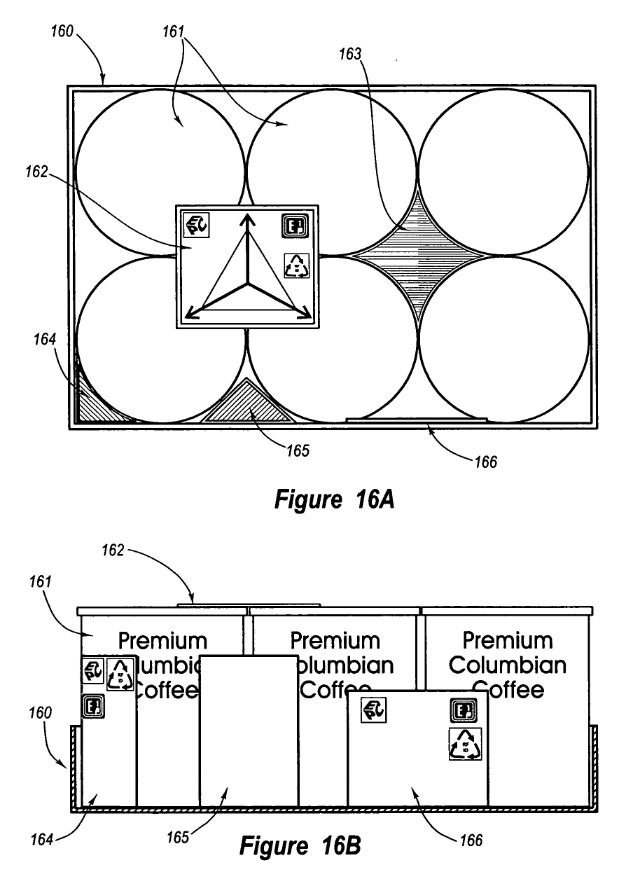

FIGS. 16A and 16B are diagrammatic illustrations of five of the many methods for placing an RFID tag that is designed to operate in close proximity to objects 161 that contain metal or liquid in a carton or tray 160. Certain embodiments use a substantially enclosed carton in lieu of a tray 160 with shrink wrap. Certain methods of associating RFID transponders 162-166 with goods 161 of this type involve placing the transponder in a preferred orientation within the carton or tray 160 at, for example, about the same time as the canned goods 161 are loaded therein. For certain transponder placements as shown in FIGS. 16A and 16B, the goods 161 may be loaded into the carton 160 before the transponder is placed inside. For certain placements on the bottom of the carton 160, transponder 163 may be placed into the bottom of the carton 160 before the goods 161 are loaded. The placement of transponder 163 may be performed prior to the wrapping of a thermoplastic shrink wrap seal around tray 160 and its contents 161. Certain transponders may also be capable of being used after the shrink wrap seal is applied, and are therefore easily adapted to certain “slap and ship” tagging methods.

The actual form and detail of transponders 162-166 may vary greatly without departing from the teachings herein. For example, certain embodiments use transponders with a thin profile to wedge into tight spaces between canned goods 161 and the carton 160. The thicker section may be positioned to overlap certain corrugated features of the carton, or fit neatly into certain voids where one layer of corrugate ends and forms a pocket into which a transponder can be placed without creating stress on transponder, package, or contents.

Other embodiments include placement of a transponder of the type shown in FIG. 15 into tray or carton 160. One method of handling a transponder on such a substrate is to place the transponder loosely into the carton using any of the several placements shown in FIGS. 16A and 16B. Transponder placement in the transport container or carton can be performed either manually or using automated methods.

In some cases, the preferred placement may be in the corner of the carton 160, as illustrated in FIGS. 16A and 16B. In certain embodiments, transponder 164 has features that retain it in the carton without using adhesives to hold it in place. The consumer goods 161, by pressing their mass and weight against the transponder 164 and the carton walls 160, may be used to help to keep the transponder in its preferred orientation in the corner. Certain such features on the transponder 164 may include more than one side and/or a bottom flange.

FIGS. 16A and 16B also illustrate another three-dimensional transponder in the form of a corner reflector transponder 165 that is placed into a gap between canned goods 161 and a wall of the corrugated transport container 160. The transponder may be of the type disclosed in U.S. Pat. No. 6,441,740 titled “Radio Frequency Identification Transponder Having A Reflector,” which is hereby incorporated by reference. Certain embodiments can use this type of transponder to improve the performance of a transponder in the vicinity of objects that contain metal or liquid, to increase gain, range, and directionality, or to fit the available space within a carton, as shown in FIGS. 16A and 16B. This type of transponder may be inserted into the carton before the shrink wrap film is applied.

In one configuration, three dimensional transponders may be constructed using paper, paperboard, cardboard, corrugate, or other cellulose fiber materials. An advantage to radiolucent cellulose three-dimensional transponder structures is that they are compatible with corrugated package recycling processes. Cellulose structures do not generally contaminate old corrugated carton (OCC) waste streams. Other three-dimensional transponder embodiments may use other materials as structural elements.

Certain three-dimensional transponders may be capable of maintaining a higher level of RF performance than a two-dimensional label applied to the outside of a corrugated carton, especially if items inside of the carton absorb or reflect UHF radio signals and have a tendency to shift inside the carton.

Certain embodiments of transponder 165 may have a substrate that is constructed from paperboard or other cellulose fiber materials. In certain embodiments, a layer of thin metal foil may be applied to the inner surfaces of transponder 165 to create a controlled reflective characteristic behind the microstrip structure of transponder 165. In certain embodiments, the foil may be made of aluminum.

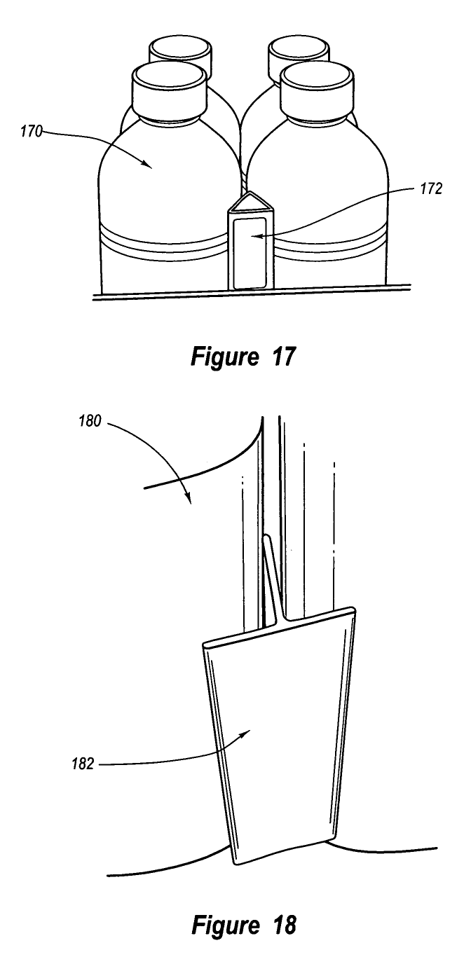

In certain other embodiments of transponder 165, no metal reflectors are used. FIG. 17 illustrates three-dimensional transponder 172, which is an embodiment of transponder 165 in which no metal reflectors are used. Improved performance may be achieved through this transponder design by using the three-dimensional shape of the transponder to maintain a preferred alignment with metal 161 or liquid objects 170 or 180 in FIGS. 17 and 18, respectively, in the carton, case, or tray. FIG. 18 illustrates another three-dimensional transponder as a T-shaped transponder 182 constructed on a folded corrugated kraft paper substrate. In certain embodiments, the transponder substrate may be made of recycled or reused OCC.

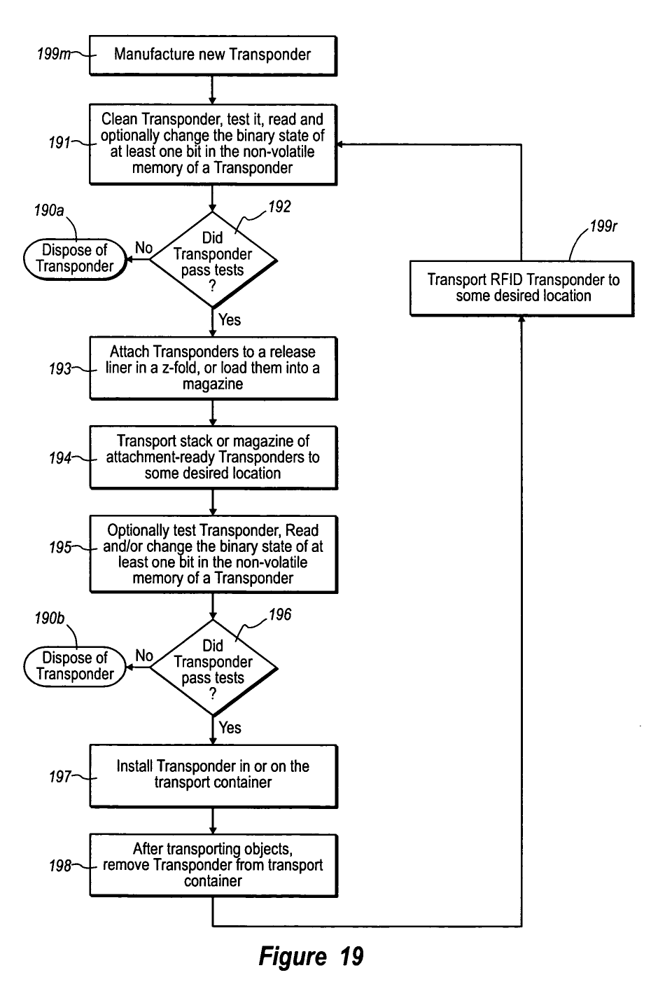

FIG. 19 illustrates a method of transponder reuse. Step 199m is a conversion step to create transponders having the markings and physical characteristics that may be preferred for this method. Certain embodiments may include standards of ruggedness to survive multiple uses. In certain embodiments, RFID inlays are manufactured in preparation for subsequent steps beginning at step 191.

With the exception of newly manufactured tags and inlays from step 199m, the first process within step 191 involves cleaning and optionally trimming the transponders and tags to remove residues, unwanted adhesives, glue, wax, packing material, or other foreign objects. Certain cleaning methods use detergent, water, bleach, disinfectants, or boiling water to kill or remove biological contaminants. Transponders or tags may be subjected to a controlled interrogation field to read and grade each transponder, possibly monitoring parameters such as activation energy, sensor performance, backscatter signal strength, read range, number or percentage of successful reads, and other indications of the quality of the tag. Good tags may then be unlocked using known or discovered passwords, then programmed with new information. In one embodiment, that information may include tracking or process control information related to the handling of reused transponders. Information about each transponder may be stored in one or more databases and correlated or indexed to previously stored information about that transponder, its history, the location at which it was most recently used, and/or where it is about to be used. That information may be stored in non-volatile memory within the RFID inlay.

Step 191 may include programming of Object Identification Data that will be needed downstream in step 197. In certain embodiments, Object Identification numbers are known or selected well before step 197. Such methods may be preferred in applications such as high speed transponder attachment where the attachment rates exceed the rate that an RFID interrogator can program and verify new transponder data or where pre-encoded tags are preferred.

Step 192 is a branch on the results of the tag testing performed in the previous step. If a tag or transponder does not satisfy the criteria of certain requirements, then it must be discarded to another location 190a by separating it from the cycle of reuse described by this method.

Step 193 is a transponder packaging step in preparation for transport and subsequent application. Certain embodiments may use rolls or z-folded transponders mounted to a continuous web or release liner.

Certain embodiments may use functional parts of tags and some residual packaging material from the previous use, and adhere it to a section of packing tape. Packing tape can be single-coated pressure sensitive adhesive tape or, alternatively, media constructed with multiple layers including a backing layer. Certain backing layers are constructed on a plastic film having one or more layers. Certain backing layers are made from plastic resins such as polypropylene (PP), polyethylene (PE), or copolymers of PP, PE, PVC, polyesters, or vinyl acetates. Certain embodiments of PP are monoaxially-oriented polypropylene (MOPP), biaxially-oriented polypropylene (BOPP), or sequentially biaxially-oriented polypropylene (SBOPP). Certain backing layers are biodegradable. Certain backing layers are coated with a pressure sensitive adhesive on one side and a low adhesion release coating on the other side.

Certain embodiments may use a recycled wireless tag attached to one or more segments of packing tape mounted to mesh and rolled onto a spool or reel. Some suitable mesh material is relatively light, inexpensive, and commercially available because of its abundant use in agricultural applications. In this novel application, mesh is used as a transport media for converted tags. In certain embodiments, mesh or netting may be made of plastic, such as nylon, polypropylene, polyethylene, HDPE, Teflon, or other resins. In certain other preferred embodiments, mesh or netting may be fabricated from metal or carbon impregnated plastic to provide a conductive path to bleed electric charge away from points of accumulation. Certain embodiments within all parts of the conversion and tag application process do not allow significant amounts of electric charge to accumulate to voltages in excess of the ESD rating of the tags. Certain rolls of stock mesh or net may be 14 feet wide and 5000 feet long, rolled onto a core. Conversion machinery cuts the mesh to preferred widths and lengths, rolling it onto a core having a preferred diameter. Certain mesh widths are approximately the same linear dimension as the length of the dipole tags that it is intended to transport to the point of attachment.

In certain embodiments, cartridges of convenient size and shape for quick replenishment of automated tag applicators are loaded with a spool of recycled converted tags mounted to a roll of mesh. Certain cartridge designs have a snap-in snap-out retaining feature that enables an operator to quickly and easily reload an applicator with a fresh supply of recycled wireless tags. Certain retaining devices may include clips, snaps, quarter-turn screws, or other mechanical latching mechanisms.

Certain tag cartridges may include an RFID tag that is permanently associated with a cartridge and may also be used to convey information between applicators and cartridge replenishment equipment. In certain embodiments, the RFID tag contains a numerical value that is directly or indirectly representative of the numerical values associated with the wireless tags stored within the cartridge, preferably at least indicating the starting numerical values of a number sequence. Other additional information is also encoded in the RFID tag in certain embodiments, including a unique identification number, certain status information from an applicator that is intended to be communicated back to a service database, the number of tag positions, the number of good tags, the ending sequence number, the date, time and place of tag conversion or other preferred commercial, logistic, or manufacturing information. Data in the tag may be used to generate an index into database records that are queried to determine which customer was the last to use that cartridge. One possible use of that information is to properly credit customers for reusing each tag cartridge.

Other embodiments may use transponders that are stacked and loaded into magazines for transport, handling, and automated dispensing. In certain embodiments, the magazines may also contain metallic shielding to protect tags and inlays from electrostatic discharges (ESD).

At step 194, one or more batches of fully tested and application-ready transponders are transported to a desired location. Certain methods of transport may include internal company transfer, less than truck load (LTL) shipment, a truckload, an overseas container shipment, a rail car shipment, a shipment by UPS, Federal Express, DHL, or other overnight carrier, or shipment via a government operated postal service.

The next step 195 is to optionally retest a transponder in order to reduce the chances for a latent failure. Transponders may then be written to such that information about the object that they are about to be attached to is recorded in the transponder's non-volatile memory. The transponder may also be commanded to store certain logistics information related to the transponder and its issuance. Such information may be stored in a separate section of the transponder's memory that is designated for such use. The transponder may then be locked using a secret password to prevent rewriting to the transponder by unauthorized users. Other embodiments may use a password to hide certain data that is not required for use by unknown or untrusted persons or entities in a chain of custody or supply chain. Such data could, for example, include certain permanent transponder identification data as described in other parts of this disclosure.

At step 196 transponders that failed to correctly perform all operations associated with step 195 are discarded to another location 190b such that they are removed from this method of transponder reuse.

In step 197 of the exemplary method, transponders are attached to transport containers, such as corrugated cartons, by feeding a continuous sequence of application-ready transponders into automated attachment machinery, such as an applicator, hand-applied in “slap-and-ship” applications, or by other suitable methods. Transponder is placed in a preferred location and orientation in or on the packaging materials of the transport container and retained in that position by, for example, any of the following:

1) A pocket, pouch, or envelope;

2) A panel or carrier with selectively applied adhesive, including a flexible thin plastic carrier, and in certain embodiments thin plastic tape with pressure sensitive adhesive on one or more surfaces, and in certain embodiments that use low cost packing tape as a pre-manufactured carrier, including opaque colored tape and printed text and/or symbols thereon;

3) A three-dimensional transponder that is retained within a transport container with the other goods contained therein;

4) The contents of the goods pressing against the inner walls of the transport container and an optional layer of thermoplastic shrink wrap. The transponder/sensor may be held in place by the forces of the goods, the container, and/or the shrink wrap all pressing against each other. The tolerance for any movement or settling may be customized for the specific circumstances of that RFID transponder/wireless sensor and transport container embodiment; or

5) Retaining clips, pins, or buttons that may be attached to packaging materials such as paperboard, corrugate or thermoplastic shrink wrap.

Step 198 may be performed at locations where numerous quantities of transponders are removed from their associated transport containers. Many of the embodiments illustrated in this disclosure salvage tags at a time prior to corrugated cartons being recycled or destroyed as used corrugate.

In certain embodiments, RFID tags and surrounding sections of OCC are cut out of larger pieces of OCC.

Tagged patches of OCC can be manually removed at any point in the recycle waste stream, including the point of initial entry all the way through to the point where the recycling process reduces the container into its constituent material fibers. Either manual or automated methods can be used.

Certain embodiments of machines that find and recover RFID tags from OCC bales may also remove polypropylene bags that are compressed and sandwiched between layers of cartons in the bale. This is a new way of recycling large quantities of polypropylene bags from retail stores. Certain RFID tag recycling machines break these bales and remove the polypropylene bags. One method is to differentiate between the densities of the two dominant materials, namely cartons and plastic bags. Since plastic bags are less dense, they can be separated from the cartons using fans or compressed air to blow bags out of a conveyed path of OCC. Alternatively, the plastic bags can be given the opportunity to decompress whereby occupying a larger volume such that portions of the bags protrude above the normal fill height of a conveyed OCC stream. Hooks may then be used to snag the plastic bags and separate them from the corrugated cartons as they move under the snagged plastic.

Tagged OCC bales generally weigh over 500 pounds and are most often moved through an OCC storage warehouse by mechanical means such as a fork lift truck. Fork lift truck drivers may be informed whether an OCC bale contains RFID tags by observing indications from an on-board RFID interrogator that penetrates layers of corrugate to determine if a sufficient amount of RFID tags are embedded within a particular bale. Bales that are worth processing to find and recover useful amounts of RFID tags may be transported to a tag recovery system that will perform that function. Bales can be transported via an infeed conveyor to a bale breaking system that begins the process of recovering plastic bags, recyclable fiber, RFID tags, and other useful recycle waste stream materials.

Cartons that become interlocked with each other during the baling process may be separated from each other and spread out along the length of a conveyor belt, between diverging conveyor belt pairs, or within a rotating drum that tumbles and separates the cartons. This is a process known as singulation. It allows the following process steps to be performed with a greater degree of efficiency. Certain drum separation methods may use pins or screws to penetrate the linerboards of cartons such that the cartons can be carried upward on the interior surface of a drum for sorting and singulation.

After cartons are singulated, allowing for certain exceptions where some cartons may be partially overlapping each other, the cartons may be scanned. One scanning method is to use one or more RFID interrogators to attempt to read any tags that are being conveyed past the reader. If a tag is broken and not responsive to RFID interrogation, then it will not be observable by an RFID interrogator. If that poses a problem, then other scanning methods may be used to detect and locate non-responsive RFID tags. Other methods include X-Ray, infrared, and various radio frequencies in the multi-gigahertz microwave bands.

RFID interrogation may be performed using apparatus that restrict propagation of radio signals beyond very localized subdivided regions across the width of the carton conveyor. Certain methods of restricting radio frequencies from propagating include the use of directional antennae, shielded panels, housings or chambers, anechoic radio frequency absorbing materials between antennae, near field couplers that have a dominant near field and a weak far field, or an arrangement of leaky coax with a dominant near field component. Magnetic fields around the radiating elements dissipate by the inverse cube of the distance from those elements, compared to electric fields that dissipate at an exponential rate. The result is that magnetic fields are much more localized than electric fields, and are therefore better suited to selectively couple with tags that briefly pass through designated interrogation zones on the conveyor.

Near field couplers can maximize the magnetic field strength relative to the electric field strength. Certain embodiments use electrically parallel zig-zag one half wavelength microstrip transmission line patterns on a printed circuit board with a separate ground plane and are terminated with an unmatched resistive load to create a localized concentration of an interrogation signal. Radio frequency signals leak from the multiplicity of microstrip edges and preferably couple with wireless tags that come in close proximity to those edges. Certain embodiments use signal multiplexers to connect an RFID interrogator or wireless tag transceiver to a multiplicity of near field interrogators or leaky coax. A dense array of near field coupling devices or leaky coax may provide a corresponding array of localized interrogation zones across the conveyed stream of singulated cartons. Each zone may be about the same size as the antenna structure of the smallest wireless tag sought for removal and reuse. Certain embodiments arrange coupling zones similar to a checker-board pattern within a two dimensional array, such that there are no RF blind spots across the width of the conveyance and such that no zone has a directly adjacent coupling zone. Such an arrangement reduces the chances for zones interfering with each other, especially at increased transceiver or interrogator power levels. When a wireless tag is conveyed into an interrogation zone created by the leaky edges of a near field coupling device, it is preferably coupled by an electromagnetic field long enough to at least perform an interrogation. Near field coupling devices for use in RFID printers are discussed in U.S. Patent Application Publication No. 2005/0045724, titled “Spatially Selective UHF Near Field Microstrip Coupler Device and RFID Systems Using Device,” which is hereby incorporated by reference in its entirety.

Once RFID tags have been detected, interrogated, and assessed within localized zones, they may be aligned with an automated cutter or other cutting device. Cutting devices include saws, knives, punches, water jets, and particle streams. Alignment can be achieved, for example, by moving the cutting device into the line of motion of the oncoming tag or, alternatively, the path of the oncoming tag can be altered to align with the position of the cutting device. Once the tag and the cutting device are laterally aligned, they can be temporally synchronized such that the cutting device is actuated when the tag passes through the working region of the cutting device. The preferred result is that the tag and a portion of the surrounding corrugated carton are removed as a combined unit.

Certain automated cutters or cutting devices can be rotated around an axis, giving them an additional degree of freedom within the plane of cartons laying flat on the conveyor. Such a rotary axis can be driven by a servo-controlled motor and gear train to certain desired angular positions. The angular positions may be determined by methods that include mechanical alignment and visual sensing. Mechanical alignment can be achieved by ensuring that cartons move along a conveyor while an edge is pressed against an alignment rail. Such a rail may be very smooth, offering a low friction surface for carton edges to ride against. The plane of the conveyor may be tilted such that gravity pulls the carton edges against the alignment rail. If visual sensing equipment is used, such as a camera or a linear array sensor, then signal processing may yield actual alignment information, thereby allowing an angular correction to be computed. An angular correction can be mechanically realized by rotating either the carton or the cutting device in a manner that is immediately responsive to the computational results from an image processing system. Such a system operates on a real time basis up to a maximum specified carton throughput speed. For example, if cartons are singulated such that a leading edge arrives at a cutting device every second, and they are scattered along a conveyor belt such that the nominal distance between leading edges is four feet, then the conveyor must move at a rate of 4 feet per second, or 240 feet per minute. Machine designs based upon conveyor speeds much greater than this must account for aerodynamic effects of air that surrounds the conveyor causing cartons to lift from a preferred orientation flat against the belt. Therefore, one design for increasing the overall throughput of a patch removal system is to operate several stages in parallel with each other. By comparison, patches that are one foot square that ride on a conveyor to support one patch per second require a belt speed of about one foot per second or 60 feet per minute. If the aerodynamic limit for one-foot square patches of tagged corrugate is 240 feet per minute, then such a line could handle the output of up to almost four upstream cutting stages.

Patches may be cut from the corrugate such that they are aligned squarely to either the carton's major axes or the tag's major axes, which are not always the same. RFID tags that were applied to cartons manually are seldom square to their associated carton. A machine vision system may be used to detect the position and orientation of the tag on the corrugate. Angular errors are computed in real time to command a coordinated angular error correction in the cutting devices used to remove unwanted corrugated material. The result is patches of uniform size and shape, with a certain percentage of them having a tag on the carton. Unless cartons are filleted open such that all faces of the carton are in contact with the conveyor belt, there is the possibility for each and every patch to have a tag on it. Otherwise, about half of the patches will have tags on them. This is because any section of the carton that is a positioned behind the tag will likely be cut when the tagged panel is cut. The likely result is that there will be two patches from each carton, one of them having a wireless tag adhered to it. Therefore, the belt capacity computation above may have to be adjusted by a factor of two. If each upstream cutting station produces two one foot square patches, then the downstream merge can only support a maximum of two cutting stations if the aerodynamic limits for the example above prove to be accurate. However, if each cutting station has incorporated into it an apparatus to remove untagged patches, then the previous downstream merge ratio of four-to-one still holds true.

Separating tagged from untagged patches may require at least a qualitative interrogation of the wireless tag on the corrugate that results in a pass or fail signal to cause a mechanical device to physically separate patches accordingly. Appropriate mechanical devices include jets of compressed air, sections of the conveyor that tilt, shoes, louvers, flippers, a rotary table, or other devices that either rotate or translate around or along at least one of six possible degrees of freedom. Untagged patches may be removed along a separate conveyance or gravity fed chute to a place where all of the rejects and corrugate trimmings from these processing stations are accumulated for rebating or for repulping.

Tagged patches may also be quantitatively tested to grade the tagged patches. For example, the strength of the backscattered signal can be used as a metric for grading. Further steps can be taken to separate or sort tagged patches according to tag test metrics. Information within the tag can also be used to sort the tagged patches into different physical storage locations. Information such as the type of tag, its original manufacturer, the commissioning CPG manufacturer, the tag's ability to be reprogrammed, the type of corrugate that the tag is attached to, the physical condition and location of the tag relative to carton edges and folds, or other selective criteria may be used to sort patches. The number of storage locations may be flexible to accommodate changes in sorting, storage, and throughput requirements.

Patches may be bundled or boxed for storage or shipment. Patches can also be soaked in water to reactivate the starch-based glue within the corrugated medium. The patches can then be compressed and dried at either room temperature, or at an elevated temperature to accelerate the drying process. Patches may dry flat within their bundle or within a drying fixture.

The back side of patches can also be trimmed when dry to remove unwanted layers of linerboard and medium that is attached to the linerboard that the wireless tag is adhered to. Dry material removal methods can be adopted from the wood products industry, including a variety of cutting, peeling, and abrasive methods of tag slimming and trimming.

The resulting tagged OCC patches may then be processed further to achieve certain shapes and sizes that are needed for subsequent reuse steps, such as steps 191 through 193. In certain embodiments, planar tags are created, as shown in FIG. 15, or such as tags 60, 70, 162, 163, or 166 as shown in FIGS. 6, 7, and 16. Certain three-dimensional transponders may be created from tagged OCC patches that are produced in step 198.

In other embodiments, transponders may spontaneously fall out of the carton when the carton is opened and emptied. In other embodiments, transponders may be easily removed when the contents of the carton are removed. One method involves catching each transponder in preparation for flattening the carton for subsequent crushing or baling operations that are typical in the stock room areas of retail stores or military exchanges.

Certain automated RFID tag or wireless sensor detachment methods may use cryogenics, and/or mechanical impact to pierce corrugate and extract the tag or force the transport container to flex in such a manner so as to break the adhesive bonds that hold the RFID tag or sensor to the container wall. Transponder substrate 151 of FIG. 15 is an example of an embodiment that may be removed by automated machinery. Transponders may be removed using mechanical force applied after cryogenic heat transfer from the region around the inlay. Certain embodiments of those machines may also perform certain tests, as described in step 191. Such tests may also or alternatively be performed in step 198 in order to determine if an RFID tag, transponder, inlay, or wireless sensor is suitable for reuse, to optionally unlock, scrub, remove, or alter data, and to optionally report data into a chain of custody.

In step 199r, bulk quantities of transponders are transported to another location for subsequent reuse. Certain methods of bulk transfer may include the use of containers, stacks, or bales of recovered and tested tags. A new cycle may begin at any of the steps 81, 91, 101, 191, or 281 from FIGS. 8, 9, 10, 19, and 29, respectively, as may be appropriate to the type of business process, transponder, attachment method, and transport container.

Internal mounting may be used for thick transponders since mounting them outside of the transport container may expose them to risk of snagging, or being unintentionally scraped off. For transponders that are insensitive to metal or liquid within a transport container, it may be acceptable to use thick transponders. Such transponders may be constructed to include, for example, any of the following: 1) a thick layer of RF absorbing material, 2) a thick layer of dielectric material backed by a layer of metallic material, or 3) a battery comprising part of a semi-passive tag or transponder.

Certain implementations of RFID transponder allocation methods may use a transponder allocation algorithm that may use, for example, any or all of the following information to determine if and when a customer's request for used transponders can be fulfilled:

1) Transponder model and type;

2) Requested delivery date;

3) Requested delivery location;

4) Number of transponders of that type that this customer has already purchased and shipped under ADASA licensing agreement;

5) Number of transponders of that type recovered from that customer via end user transponder recycling;

6) Number of transponders currently in the supply chain in association with certain goods shipped by that customer, but have not yet been recovered for recycling;

7) Location of used transponder inventories that are required by that customer;

8) Logistics and associated costs that are required to deliver certain inventories to meet that customer's delivery request;

9) Order history of that customer; and

10) Forecast of future availability for tags of that type.

Password generation methods are disclosed below. For certain embodiments, passwords may be safeguarded using cryptographic techniques, secure and trusted channels, locked memory, and/or other methods that are commonly used to protect confidential information. Passwords may be generated or retrieved as follows:

1) Data from a tag or transponder may be used to generate an index into one or more databases that contain any of the following:

a. A one dimensional array of passwords;

b. A two dimensional array of passwords;

c. A multidimensional array of passwords; or

d. An array of actual or pointers to algorithms used to generate passwords from tag data.

2) Cryptographic algorithms may be used generate passwords from tag data.

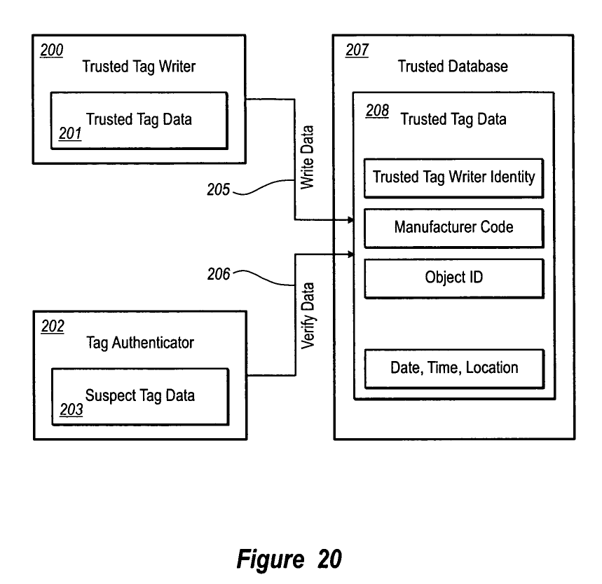

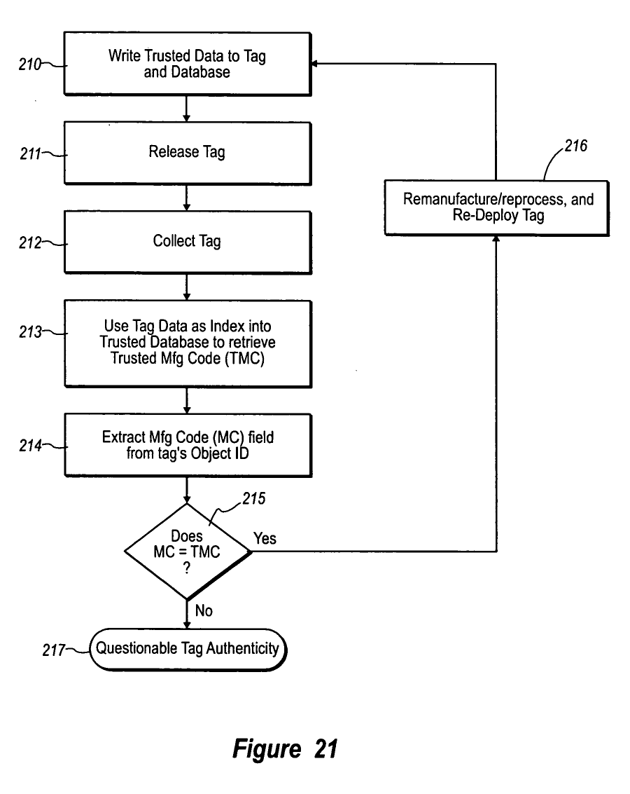

Referring to FIGS. 20 and 21, a method is described for authenticating tags that have traveled through an unsecured channel. In the first step 210, a Trusted Tag Writer 200 writes data to a tag and to a Trusted Database 207. Trusted Tag Writer 200 stores and may use passwords required to read and write certain data to and from tags and transponders, as described in other parts of this disclosure. Data records of all data transactions may be recorded in a secure database and accessed over a secure connection 205. Data record 208 may be pointed to by an index that is derived from Trusted Tag Data 201. For certain embodiments, Trusted Tag Data 201 can only be read or written using secure credentials, such as a password or an encryption key. Trust is maintained because an unauthorized party cannot easily duplicate Trusted Tag Data 201 because it cannot be read or overwritten without a known set of values. In such embodiments, certain other fields may be left unsecured such that anyone can read them. For certain embodiments, permanent transponder identification data may be protected from reading or writing by unauthorized parties, and object identification data may likewise be protected from being overwritten, but nevertheless can be read without authorization credentials. For such an embodiment, object identification data may include a serialized GTIN that is composed of certain data fields, including a company prefix that represents the identity of an EAN/UCC authorized manufacturer. For certain embodiments, a company prefix is encoded as a Manufacturer Code in Tag Data Record 208 of Trusted Database 207 with an index to it that is derived from Trusted Tag Data 201.

Transponders may be released at 211 to flow through unsecured channels such as sales channels, supply chains, interconnected trading partner relationships, and global trading arrangements. While in these channels, transponders can be stolen, cloned, copied, diverted, or altered.

Transponders may be collected at 212 from end users channels after they have been detached from the object that they were associated with.

In step 213, Tag Authenticator 202 begins by reading tags of unproven authenticity. For certain embodiments, an index or reference pointer can be derived from tag data that can only be read using a secret code such as a password or decryption key. Certain embodiments read permanent and unalterable sections of transponder memory to obtain a unique index or reference pointer. In certain embodiments, tag or chip manufacturers encode unique serialized numbers into unalterable parts of transponder memory. In certain embodiments, such a number is referred to as a TID and it remains unchanged throughout the life of the transponder. In any case, such an index may point to a Tag Data Record 208 in a Trusted Database 207. The Suspect Tag Data 203 may contain certain data that is also stored in certain fields of the aforementioned Tag Data Record 208, including the Manufacturer Code.

Referring now to step 214, the Manufacturer Code field may be synthesized from data that is read from generally publicly readable object identification code in Suspect Tag Data 203.

In step 215, the Manufacturer Code from the Suspect Tag Data 203 is compared to the Manufacturer Code that was stored in the Tag Data Record 208 of a Trusted Database 207 and, if they match, then the process advances to step 216. Otherwise, it regresses to terminal step 217.

For certain other embodiments, other corresponding data fields could be stored and compared in an authentication step using a process similar to the one illustrated in FIG. 21 using data that is similar to the data shown in FIG. 20. If the data that is stored in the corresponding fields matches, then the suspect tag is deemed to be authentic.

In step 216, the tag is reconditioned using any of a variety of steps including cleaning, sorting, testing, grading, weighing, inspecting, data extraction, changing data, passwords, or control bits, slicing, trimming, folding, repackaging, and/or transfer or shipment to some desired location where the process can again restart at step 210 or another similar step described in other parts of this disclosure. As part of the reconditioning step, in some embodiments the tag may be partially remanufactured as well.

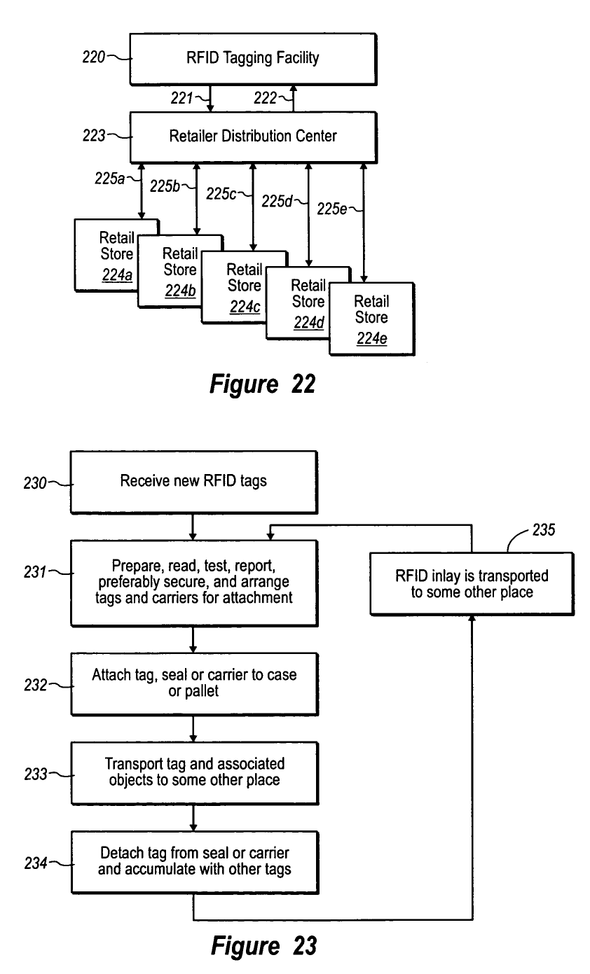

FIGS. 22 and 23 illustrate certain methods of reusing RFID tags and transponders in a trading relationship that has certain closed loop attributes within a larger system of commerce. Methods of tagging corrugated cartons and pallets to comply with certain logistics requirements involve attaching RFID tags after goods have been shipped from a manufacturing or packing plant. Goods may be received into an RFID Tagging Facility 220 that may provide certain services including, for example, RFID tagging, transportation, logistics, and data management services. At such a facility, new tags may be received, as shown in step 230 of FIG. 23. Such tags may conform to certain design criteria for being used in a manner that conforms to at least one method disclosed herein.

In a subsequent step 231, RFID tags and transponders are prepared for use or reuse. If tags need to be cleaned, one or more tag cleaning operations may be performed to remove residues and foreign objects. Certain sanitation requirements may apply for food, pharmaceutical, or medical shipments. Tags may also be read to extract old data to be stored, reported, used to authenticate the tag, used to determine where certain tags came from, used to sort tags in preparation for using the proper type of tag in subsequent applications, or used to generate records of donated tags. Tags may then be mechanically arranged, stacked, or otherwise prepared for being applied to a new object.

In step 232, tags are attached to an object with which they are to be logically associated. Tags may be attached using any of the several preferred methods disclosed herein.

In step 233, tags and the objects that they are attached to are sent through a distribution channel 221 to a distribution center, such as the type used by certain retail chains or military logistics and distribution networks. Certain retail or military distribution networks may use wireless sensors to track and trace shoes, clothing, apparel, accessories, handbags, leather goods, dry goods, auto parts, electronics, appliances, or other manufactured items. Tags and tagged cartons and tagged pallets may also be transferred through distribution channels 225a-e to stores, pharmacies, military exchanges, or other supply chain end points 224a-e where items may be removed from corrugated cartons, pallets, and transport containers.

In step 234, tags are removed from the objects that they are attached to, preferably using methods and embodiments disclosed herein, or equivalent or obvious methods and embodiments suggested by this disclosure to those of ordinary skill in the art, without damaging the tags or transponders. Tags may be accumulated locally to be combined later with other accumulations of used tags.

In step 235, inlays, inlets, tags, and transponders are transported to another location, possibly along a bidirectional distribution and reverse logistics channel 225a-e to a hub or distribution center 223. These items may then be forwarded along reverse logistics path 222 to RFID Tagging Facility 220.

After tags arrive at RFID Tagging Facility 220 or another similar location, the process may be repeated once again by executing step 231 as described above.

FIG. 24 diagrammatically illustrates an old corrugated carton (OCC) 240 with a smart label (i.e., a printed bar code label with an embedded RFID inlay) 241. Certain methods of reusing an RFID tag involve the extraction of a used RFID tag from a corrugated carton. Certain extraction methods are manual, while others are automated. Certain extraction methods may be performed at or near the point when a transport container is emptied, while other methods are performed where substantial quantities of discarded containers are collected for recycling.

Some automated methods may involve cutting, slicing, or punching a wireless sensor from OCC. Some such methods may use various numbers of steps and cutting operations to reduce a tagged OCC patch to a preferred size and shape. In some such methods, the extracted patch may be formed into three-dimensional shapes according to custom requirements.

In some methods, steps may be taken to prevent RFID inlays from directly contacting aggressive adhesives, while other methods may involve removing, deactivating, and reactivating such adhesives after each use.

Some methods of adhesive removal may include soaking smart labels in water to weaken facestock fibers and adhesive, or to soften and remove scraps of residual corrugate to within certain preferred tolerances of the original label size.

Some methods of deactivating adhesives may include “reversible adhesion” to electrically disbond an RFID tag from a transport container, thereby allowing it to be reused. An example of such an adhesive was developed by EIC Laboratories in Norwood, Mass. Some methods of removing used RFID tags with reversible adhesives may include inducing temperature changes to switch an adhesive from “sticky” to “not-sticky”, as has been developed by researchers at Elf Atochem and National Center for Scientific Research in Paris. A method of attachment, detachment, and reattachment may use regions of thermally removable epoxy bonds that are subjected to elevated temperatures to reverse the chemistry long enough to detach the RFID tag, which will then rebond when the epoxy is cooled. A representative epoxy for this purpose that was developed by researchers at the Sandia National Laboratories releases at 100-130 degrees Celsius depending on the formulation, and rebonds between 20 and 60 degrees C.

RFID tags and inlays that use high temperature thermally removable adhesives may have substrates with a melting point well above the adhesive release temperature range, and that temperature may be above the required operating range of the RFID tag or inlay. Embodiments of a thermally removable RFID tag or inlay may use regions of selectively applied adhesive to allow thermal release without risking damage to the RFID chip, antenna, or substrate. Certain embodiments may reuse the facestock, while others do not.

One RFID tag attachment method uses selectively applied regions of reversible adhesion around the perimeter of a panel.

Many adhesives, including aggressive acrylate adhesives, lose their stickiness below about −65 degrees Centigrade. At temperatures below about −7 C, acrylate adhesives do not re-bond, allowing for handling of detached tags. In certain methods, wireless tags are removed from fiber, plastic, or metal when bonding adhesives are subjected to cold or cryogenic temperatures. Certain embodiments may use dry ice (−78.5° C.), liquefied Nitrogen (−196° C.), Argon (−186° C.), Oxygen (−183° C.), or Helium (−269° C.) to deactivate the adhesive bonds without damaging the wireless tag as it is removed.

Many retail stores collect OCC for sale to dealers and recyclers. Bales of OCC regularly accumulate in and around retail stores between the times that they are loaded onto trailers and removed. Outdoor OCC accumulation can result in it being dampened by rain or melted snow and ice. Damp OCC is limp, and wet OCC lacks the ability to hold its shape.

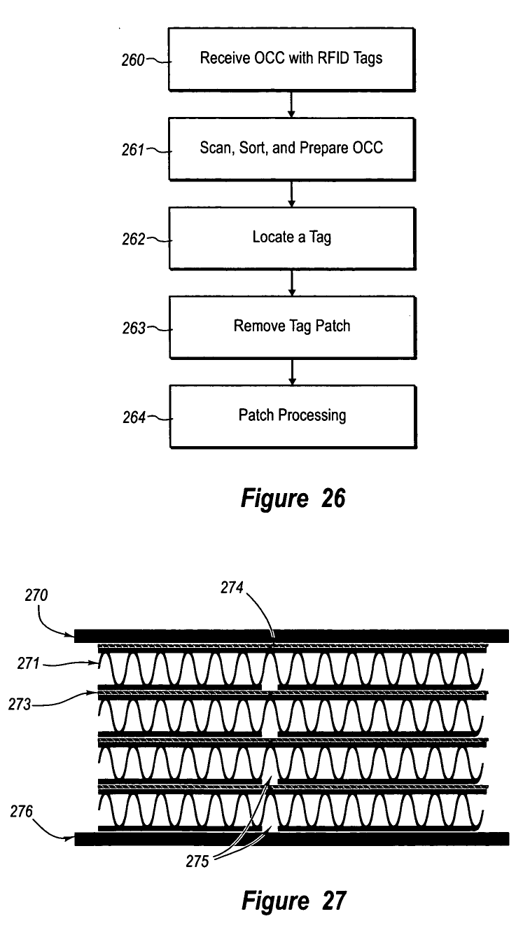

Referring to FIG. 26, during OCC baling processes, corrugated cartons are compacted in random orientations, resulting multiple crease lines and overall loss of the carton's original rigidity. OCC bales or loose OCC arrive at sorting facilities, as shown in step 260. Some of the tag extraction methods and devices disclosed herein allow for processing of tags on limp and/or creased OCC.

Step 261 involves scanning the OCC with RFID interrogation signals in order to detect RFID tags that are responsive to certain known air interface frequencies and protocols. Certain RFID interrogators are capable of interrogating RFID tags using multiple frequencies and multiple protocols. Such a process may be able to detect RFID tags that are compliant with various RFID air interface specifications and standards. Step 261 may be performed at different frequencies using different protocols to determine if RFID tags are present. Sorting OCC may result in verification of each piece of OCC to prevent RFID tags from flowing into downstream OCC repulping processes. OCC with RFID tags are prepared for the next step, while OCC without RFID tags may be forwarded onto the repulping process.

Step 262 may utilize machine vision equipment, including optical, infrared, or radio frequency imaging, to locate the position of an RFID tag or wireless sensor 241 on a piece of OCC 240. Automated tag recovery systems may use that location information to guide recovery apparatus to the precise location of RFID tag 241. Manual tag recycling requires the use of human labor to visually locate RFID tag 241 on OCC 240. In either case, the OCC may be inspected on all surfaces to locate RFID tag 241.

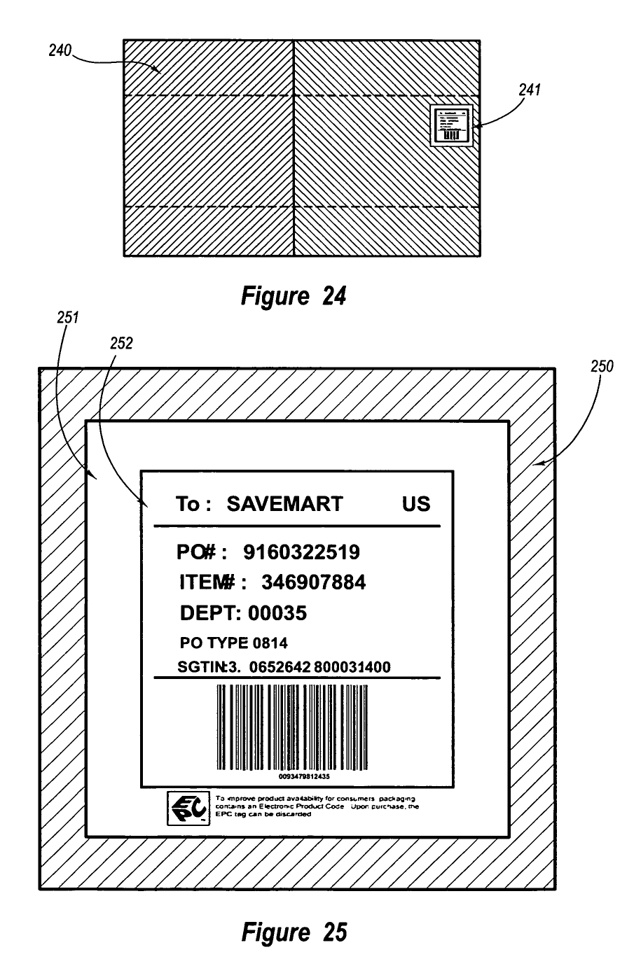

In certain embodiments, the location of wireless sensor 241 on OCC 240 is stored in a database. Certain methods of storing wireless sensor 241 location on OCC 240 may use empirical data from previous successful searches for tag 241. Certain other methods involve storing tag location information through the download of tag location coordinates, through, for example, a communications network. Tag location coordinates may be provided by a cooperative party, a trading partner, a consumer packaged goods company, or by another tag recovery machine. Certain embodiments use a coordinate system that is referenced to identifiable features on the piece of OCC 240. Certain identifiable features may include, but are not limited to, the edge of a carton, a fold, flap, label, or printed feature on the carton or piece of OCC 240. In certain embodiments, printed labels may also contain an RFID tag, transponder, or wireless sensor under the printed facestock. Certain identifiable features may be recognized by machine vision equipment. Certain methods of label recognition may involve the use of templates or descriptions of the characteristic features of the label, such as the printed area 252 of the smart label 251 shown in FIG. 25. In certain embodiments, templates or other descriptive or characteristic information may be retrieved from one or more databases that may be referenced or pointed to by information that is read from the memory of its associated wireless sensor.

Referring again to FIG. 26, process step 263 is directed to the removal of a patch of tagged OCC from larger pieces of corrugated cartons of the type depicted in FIG. 25. Extracted patches may be rectangular and may also contain a wireless sensor, RFID tag, or transponder. The primary axis of the extracted patch 250 may be parallel to one of the major axes of the tag or wireless sensor, as shown in FIG. 25.

Due to random creases and damp OCC, any single carton cannot be expected to be crisp or aligned in any particular orientation. On the contrary, OCC is generally limp and prone to flexing under mild stress. Therefore, removal of RFID tags from OCC may be done using methods that do not depend on stout corrugate. Such methods of RFID tag removal include, but are not limited to: suction, sawing, slicing, piercing, ripping, water jet cutting, stamping, punching, or combinations of these methods.

In process step 264, untagged OCC may be baled or sent directly to a repulper, while tag patches may be processed separately. Tag patches may be reconditioned to meet certain sets of customer requirements. Certain processing steps include cutting, aligning, trimming, planing, sanding, removal of selected corrugate linerboard layers, removal of corrugate medium layers, reading or changing data in the non-volatile memory of the RFID tag or wireless sensor, testing performance characteristics, machine vision inspection, encapsulation, and/or other value-enhancing steps. Certain processing methods include the use of ultra-wideband (UWB) imaging or other radio imaging systems to visually penetrate corrugated container walls to reveal the metallic antenna of an RFID tag, inlay, transponder, or wireless sensor. Certain processes trim away packing material, corrugate, and adhesive label stock to within relatively close proximity to the RFID tag. Certain label applicators may reuse RFID tags trimmed very close to the antenna.

In certain implementations, after reading, testing, and writing data to a transponder on a tagged OCC patch 250, the fluting medium is wetted to reactivate the adhesive therein. Wetting methods may include selective injection of water into the flutes, soaking the patch in water, or wetting with an adhesive fluid. Wetted patches may be dried at either elevated or room temperatures. Certain implementations use a method of removing atmospheric moisture in the vicinity of wet patches. Some methods involve stacking many wet patches together, as shown in FIG. 27. Others may use platen 270 and 276 to compress the tagged OCC while the patches dry to a preferred level of water content. Certain methods separate the wet patches with a material that will not stick to the patches when they are dry. Certain transponder separation materials include release liner or recycled release liner arranged between the transponder patches.

Certain processes for automated patch recovery and compression, as shown in FIG. 27, include a step of creating a pressure relief hole 275 for the circuitry 274 of the wireless sensor or RFID transponder. Certain methods locate the bump where the integrated circuit 274 is mounted to an antenna of an RFID tag or inlay 273, and create a small hole in the linerboard of corrugate 271 opposite the integrated circuit die.

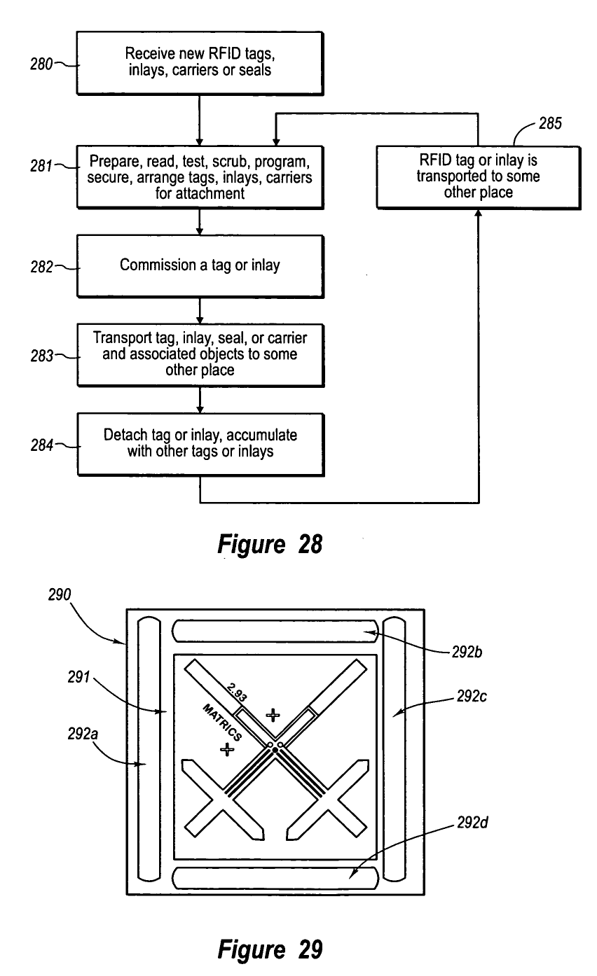

FIG. 28 illustrates certain methods for reusing RFID tags. In step 280, new tags, inlays, seals, and/or carriers are received for use in certain tagging operations. Such tagging operations may use tags that conform to certain design criteria for being used with at least one method disclosed herein.

In a subsequent step 281, RFID tags, inlays, inlets, and/or transponders are prepared for use or reuse. If tags need to be cleaned, one or more tag cleaning operations may be performed to remove residues, unwanted adhesives, glue, wax, packing material, and foreign objects. Certain applicable sanitation standards for food, pharmaceutical, or medical containers may require preferred sterilization or sanitizing procedures for the reused RFID tags, transponders, or inlays. Sanitizing steps may use detergent, bleach, disinfectants, anti-infectives, or boiling water to kill or remove biological contaminants.

Certain preferred tests may also be performed to determine if a transponder, tag, or inlay is suitable for commissioning. Such tests may include measurements of activation energy requirements, backscatter signal strength, frequency response, read range, number or percentage of successful reads, sensor performance, or other parametric tests to determine if a wireless sensor, transponder, tag, or inlay does not meet certain acceptance requirements.

Reused wireless sensors, tags, or inlays may be read to extract old data to be stored, reported, used to authenticate the tag, used to determine where certain tags came from, used to sort tags in preparation for using the proper type in subsequent applications, and/or used to generate records of donated tags or tags that are subject to eWaste fees.

Additional steps may be undertaken in certain embodiments for recording tracking or process control information related to the handling of reused transponders. Information about each transponder may be stored in one or more databases and may be correlated or indexed to previously stored information about that transponder, its history, from where it was most recently used, and/or where it is about to be used. That information may be stored in non-volatile memory within the RFID inlay.

Certain methods of counterfeit detection may use tag data to authenticate a wireless sensor, tag, or inlay and, by extension, the object or transport container that it was attached to, and, again, by extension, to the actual goods transported by that referenced container. Compared to data obtained from tracking a disposable RFID tag, the quantity of “chain of custody” data is greater for a tag that has been reused. Persistence of data within databases used to support an RFID tag or inlay recycling/reuse operation may enable searches into the entire history of any reusable RFID tag. Using such methods may therefore enable crime investigators to determine where counterfeiters obtained their RFID tags and inlays because the history of reused tags is retained in database records that are linked forward and backward with each cycle of tag/inlay reuse.

In applications where the persistence of old data could be a security risk or cause privacy concerns, wireless sensors, tags, transponders, inlays, or inlets may be scrubbed of old data by altering the state of one, some, or all bits of various parts of tag or inlay memory banks.

Floating gates memory cells may be used in non-volatile memories to retain the state of memory when power is removed. Certain non-volatile memories can be reset to an unprogrammed state by forcing the charge trapped in floating gates to leak out. Charge normally leaks out after several decades; this is effectively an accelerated aging process for non-volatile memories. Care should be taken to avoid excessive current and localized overheating of the RFID tag's memory cells when electrons tunnel through the oxide or poly layers. Some implementations may use alpha particles, high energy electromagnetic pulse, a microwave pulse, high energy gamma ray or X-Ray from a radioactive material such as Cobalt-60 or Cesium-137, an electron beam, or a localized electric field. Some methods using an electric field may use electrodes positioned very close to, perhaps immediately above and below, the RFID integrated circuit to create an electric field that exceeds the threshold voltages for the floating gates in the die such that electrons are either injected into or extracted from the floating gates therein. The electric field may also be pulsed and/or current-limited to avoid damage to the die. The result in some implementations is a wireless chip with all of the memory cells erased.

As an alternative to data scrubbing, new data may be written to tags and inlays if the required information is available and the business process supports or requires tag programming at this point—such tags are effectively preprinted labels.

Tag or inlay non-volatile memory may be secured using passwords or encryption to prevent unauthorized writing or reading of a tag or inlay's non-volatile memory. Tag or inlay non-volatile memories may be left unlocked when there are no means of securely unlocking them. Locked tags may be unlocked using known passwords, but may also be unlocked using previously known or recently discovered passwords.

Prior to advancing to the next step, old tags, inlays, seals, or carriers may be mechanically arranged, stacked, converted, rolled, or otherwise prepared for being applied to a new object or transport container.

In step 282, wireless sensors, tags and inlays are commissioned for use. They may be attached to an object with which it is to be physically and logically associated. Tags may be attached using any of the several preferred methods disclosed herein. Many of the methods described herein involve the use of pockets, panels, seals, carriers, packing tape, bands, or studs in such a manner that the tags can be easily or automatically cut, detached, or removed from the associated object or transport container for reuse. Certain methods also include tags that are attached to transport containers using adhesives that can be easily removed, dissolved, or deactivated during certain tag recycling procedures. Another method is to use a shuttle or other device to embed or implant a wireless tag that is still attached to its recycled linerboard substrate in between the corrugated layers of a carton wall. Certain pharmaceutical products may be identified using an RFID transponder embedded in the lid of a bottle, allowing for the opportunity to reuse the lid as well as the transponder. Certain other containers are themselves reusable, including an embedded RFID tag or transponder. Whatever the method of attachment, in some applications, the tag may be allowed to be separated from a recycle waste stream such as OCC, glass, metal, or plastic.

If the wireless sensors, transponders, tags, or inlays do not already contain the appropriate and correct information, then their non-volatile memories may be programmed with that information before the next step.

In step 283, wireless sensors, tags, transponders, inlays, inlets, seals, or carriers and the objects or containers that they are attached to are sent to some other location where items are removed from corrugated cartons, cardboard boxes, pallets, bottles, cans, vessels, or transport containers. Tagged items, such as tires, may comprise a shipping unit complete with a tag that will typically be removed before a tire is mounted on a wheel rim.

During step 283, the tags may be read or written to at various checkpoints or choke points along the way. During step 283, wireless sensors, transponders, or wireless tags that are capable of collecting other information such as location, temperature, barometric pressure, humidity, nuclear radiation, biological information, interrogator interactions, or other measurable conditions or events may do so as may be required by its owner, commissioner, government agency, or recipient.

In step 284, wireless sensors, tags, transponders, inlays, inlets, or lids are removed from the objects that they are attached to, preferably without damaging the reusable portion of tags, transponders, inlays, or inlets. Such tagged objects may include corrugated cartons, cardboard boxes, pallets, shrink wrap, plastic bottles, cans, glass bottles, vessels, tires, or transport containers of various types. The removal of the tag, transponder, inlay, or inlet may be performed at the peak of its value, before it becomes damaged, but preferably after its value as an automatic identifier has been fully realized within the system it operates. Referring to FIG. 11, systems that reuse or recycle containers or constituent materials, such as corrugate, glass, metal, and plastic, may use RFID technology to efficiently and accurately identify and sort such containers, objects, and materials in order to maximize the effectiveness of such recycling and reuse systems. Tags and inlays may be separated from waste streams as soon as reasonably possible after the last interrogation to provide useful information to its associated information system, but before malicious use of its data poses a security or privacy risk.

Certain methods use automated detachment means, such as, for example, multi-station conveyor lines, robots, and/or automated tools to sense, seek, and detach RFID tags or inlays for separation from waste streams such as OCC, glass, metal, or plastic. Each of the foregoing are examples of automated means for removing permanently attached wireless tags from the containers for recycling.

Some such attachment means may be well-suited to either manual or automated tag detachment methods, such as those that use smart labels, inlays, panels, carriers or seals.

Certain methods of tag detachment may involve slicing, cutting, chemical treatment, adhesive bond reversal or deactivation, cryogenics, a high impact probe, flexing of the container to break tag adhesion or to pop a tabbed retainer, soaking, corrugate disintegration, or some combination of these methods to remove and reuse the tag or inlay. Some such methods may involve adhesive bond reversal or deactivation and may be performed using equipment that is capable of operating at speeds sufficient to support large scale tag recycling operations. Some such methods may use heated plasma, steam, infrared light, a jet of hot air, a bath of hot or cryogenic liquid, agitation, ultrasonics, and/or other controlled or agitated source or sink of heat to release large quantities of RFID tags or inlays very rapidly. Other methods may use regions of electric fields to reverse adhesive bonds for rapid tag detachment.

Certain embodiments of automated removal machines may also perform certain tests as described in step 281 in order to determine if an RFID tag, transponder, inlay, or wireless sensor is suitable for reuse, to optionally unlock, relock, scrub, remove, or alter data, and to optionally report data into a chain of custody.

Whichever of the several methods are used to detach tags in various preferred locations, tags, sensors, and inlays may be accumulated locally in a container. Such a container may have an RFID tag identifying it. Such containers may also be secured to prevent unauthorized or premature access to the RFID tags or inlays stored inside of it. Such containers may be made of a variety of materials or be made in a variety of shapes and sizes. Small accumulations may be combined with large accumulations of used tags. Containers may also be cooled to below 10 degrees centigrade if they contain detached adhesive-backed tags without release liners.

In step 285, inlays, inlets, tags, wireless sensors, and transponders are transported to another location, such as along a bidirectional distribution and reverse logistics channel to a hub or distribution center. From there, these items may be forwarded along a reverse logistics path to an RFID tag/sensor recycling/processing facility. The items may alternatively be sent directly from numerous points of collection to a smaller number of RFID tag/sensor processing facilities. Methods of transport for such direct routes may be through the use of commercial couriers or governmental or international mail services.

After tags arrive at an RFID tag commissioning facility or other similar location, the process may be repeated once again by beginning at any of steps 81, 91, 101, 191, or 281 from FIGS. 8, 9, 10, 19, and 29, respectively, as may be appropriate for the type of preferred business process, transport container, transponder wireless sensor, and attachment method.

Exemplary methods of RFID transponder, tag, inlay or wireless sensor recycling are described in FIG. 10. One implementation of step 102 is illustrated in FIG. 29, whereby adhesive strips 292a, 292b, 292c, and 292d are selectively applied around the perimeter of a panel 290 that carries an RFID inlay 291. The adhesive preferably does not contact any sensitive electronic components, such as inlay 291. A similar application of selectively applied adhesive may be applied to the back side of substrate 151 in FIG. 15, as may be required for automated removal by automated methods and apparatus.

Step 103, step 197, or step 282 of FIGS. 10, 19, and 28, respectively, may, for example, be performed using panel 290 or substrate 151 attached to a wall of corrugate.

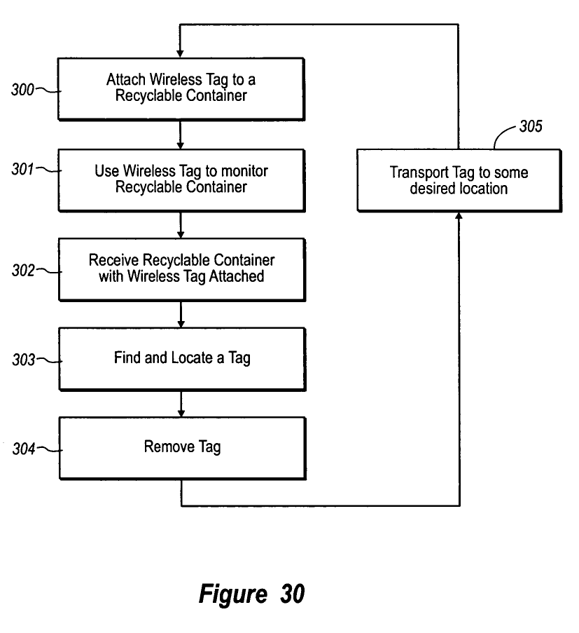

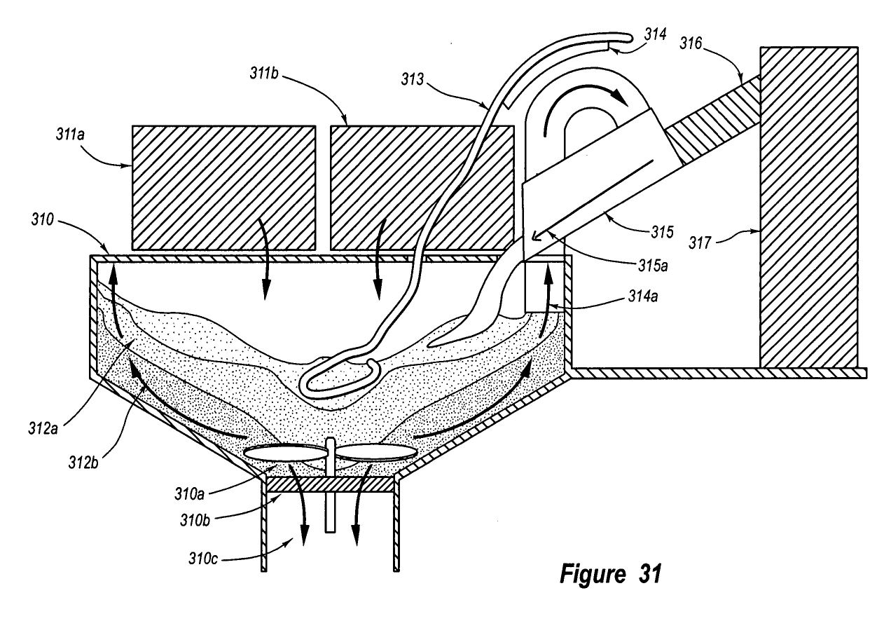

The flow chart of FIG. 30 illustrates an exemplary method for removing and reusing wireless tags from certain biodegradable or recyclable containers, such as corrugated cartons, glass bottles, metal cans, or plastic containers. Step 300 may be performed at the point at which a tag is commissioned for use, when a tag is typically programmed and physically attached to an object or recyclable container, and when tag data is typically associated with the object. Records may be made in suitable databases in order to logically bind the tag with the object, and to share that information with other computer databases, trading partners, or regulatory authorities. Certain attachment methods and embodiments for seals, pockets, carriers, and tags are disclosed herein.

In step 301, the wireless tag is interrogated by authorized RFID readers, access points, or other wireless tags on a peer-to-peer basis. The tag and the recyclable object or container to which the tag is attached may be transported to one or more desired locations, being interrogated at various times and places preferably only by authorized devices and information systems.

In step 302, the wireless tag is interrogated to determine which container or material handling process should be used. The tag may communicate certain preferred tag removal information to an authorized tag removal system. The tagged container may be received into one of a certain preferred type of apparatus that will remove the wireless tag from the recyclable or biodegradable container, preferably without damaging the tag. Certain embodiments for executing such a tag removal are illustrated and described herein. There are various systems/methods/parameters for removal of a tag from corrugated cartons, glass jars and bottles, metal cans, or plastic jugs or bottles. Certain embodiments receive recyclable containers in bulk quantities, while other embodiments are optimized for receiving them in single piece units. Certain embodiments that receive recyclable containers in bulk quantities may implement at least one mechanism to feed recyclable or biodegradable containers one-at-a-time into the subsequent processing steps.

In step 303, the wireless tag may be detected and located by one or more sensors, such as optical sensor arrays or area imagers such as CMOS or CCD cameras, RFID readers, proximity sensors, magnetic flux sensors, capacitive or electric field sensors (also referred to as charge transfer sensors), radar, infrared, UV sensors, X-ray, or a preferred combination of these to detect and locate wireless tags for harvesting, removing, inspecting, reading, writing, repairing, or sorting them and the objects, materials, or containers they are attached to. Sensor information may be processed by certain computing equipment, such as a machine controller, in order to direct the actions of the subsequent step.

In step 304, the wireless tag is preferably removed without damaging it. Removal may be facilitated via an Ejection System 43 as described above. The Ejection System 43 may be activated by contact from the removal machine, but may also be activated by a secure or encrypted signal (wireless or via physical contact) from an authorized tag removal machine. Other suitable methods of removal include use of reversible adhesives, controlled failure of adhesive bonds, removal from a seal, pocket, or carrier, removal from clips, buttons, studs, thread, wire, or other means of attachment. Other removal systems may employ blades, flex rollers, pointed probes, suction heads, water jets, ultrasonic transducers, heat, cryogenics or near cryogenic temperatures, electric fields, magnetic fields to separate wireless tags, RFID transponders, or inlays from recyclable or biodegradable containers or portions thereof. The recyclable or biodegradable container may enter a preferred waste stream without a wireless tag or its constituent materials contaminating it. In certain embodiments, the wireless tag is tested, graded, and sorted. Parameters for testing may include identification of the tag manufacturer, type, version, age, shipper, minimum activation energy, sensor performance, backscatter signal strength, angular sensitivity, read range, number or percentage of successful reads, battery life, or certain other preferred metrics.

In step 305, certain tags are accumulated and may also be transported to some desired location for reuse or for additional preparation such as data scrubbing, record verification, authentication, testing, sorting, or cleaning.

FIG. 31 illustrates an OCC repulper 310 with an automated tag recovery system comprised of separation chamber 315, Rinse and Final Separation Chamber 316, and tag sorter 317. The apparatus illustrated in FIG. 31 is one embodiment of a device to facilitate execution of steps 84, 94, 104, 147, 198, or 284 from FIGS. 8, 9, 10, 14, 19, and 28, respectively. This embodiment pertains to an OCC recycling process where the cost of removal is relatively low, and the value of the recovered transponder, tag, or wireless sensor is at or near its peak value.

One OCC repulper 310 that may be used with minor modifications is of the type manufactured by numerous companies, including the Beloit-Jones Vertical Barracuda® and Shark® Pulpers from GL&V Pulp Group, Inc. of Nashua, N.H. Minor modifications of pulper 310 include provisions for mounting duct 314, separation chamber 315, and ensuring that paper fiber stock 312a circulates properly to disintegrate fibers and provide an upward flow of stock and wireless tags into duct 314.

In an exemplary recycling process, broken OCC bales 311a and 311b are conveyed and dropped into corrugate pulper 310 that may mix the OCC in a watery solution. Coarse screening 310b at the pulper outlet can be used to remove the largest contaminants, and the pulp is pumped 310c to a dump chest, a filter system, or a detrasher for removal of heavy contaminants, such as staples and paper clips. Ragger 313 may remove baling wire, labels, and tape, and may also remove flexible wireless tags and inlets. Tags may be salvaged from the ragger, but less flexible wireless tags may, in some implementations, not be captured and removed from the pulper by ragger 313.

Rotor 310a disperses paper fiber stock 312a by agitating OCC, preferably without damaging wireless tags. Currents circulate a slush 312b of paper fibers, baling wire, labels, tape, wireless tags, and other debris throughout the inside of pulper 310. A portion of stock 312a may be captured and carried upward by duct 314. Upward conveyance 314a may be achieved by use of an auger, pump, conveyer, a mesh belt, a series of rollers, or other similar means.

In certain other embodiments, wireless tags are captured in debris traps and secondary fiber recovery systems associated with OCC repulper 310.

Separation chamber 315 may be used to separate relatively rigid wireless tags, panels, or carriers from relatively waterlogged and limp corrugate, tape, labels, and disintegrated fibers. The dissimilar flexure characteristics of the relatively rigid tags may allow them to be conveyed upward to the Rinse and Final Separation Chamber 316. Tags having a relatively stiff panel, carrier, or inlay encapsulation may be transported into Tag Sorter 317 for testing and sorting of salvaged tags.

Certain alternate embodiments may use gravity to remove pulp and tags from pulper 310 and separate tags from pulp using mesh conveyor belts and water rinses to wash pulp into a recovery stream 315a back to pulper 310.

Certain variations on the basic hydra pulper design illustrated in FIG. 31 include the D Type Hydra Pulper manufactured by the Kyoung Yong Machinery Co., Ltd. of Danwon-gu Ansan-City, Kyung Ki-Do, Korea. Such designs are already well-suited to wireless tag recovery because their inherent design reduces horizontal stock (i.e., pulp) circulation and reinforces vertical stock flow that will enhance certain preferred tag removal and salvage embodiments.

Other methods of wireless tag removal from corrugated carton repulping processes use a horizontal drum pulper, such as those manufactured by companies such as Voith Paper Automation Inc. of Germany or Andritz of Austria. Voith manufactures a TwinDrum™ that uses one drum for prescreening and a second drum for pulping. The drum screen may be used to remove wireless tags and coarse trash without breaking it down into smaller pieces. Such equipment may also remove semi-rigid plastic RFID tag panels, carriers, or encapsulated tag inlays, preferably without significant fiber loss or damage to the tags.

Various modifications to OCC pulpers may result in stock circulation that carries detached wireless tags such that they are captured, conveyed, pumped, or otherwise automatically removed from the pulper. Adequate stock circulation may be required to avoid clogging of pulp screens, manual removal of tags from the pulper, or manual recovery of tags from trash.

The buoyancy of tags may be matched to the preferred type of stock circulation currents in the pulpers that are to recover tags. High buoyancy tags may be removed, as they float on the surface of the stock. Low or negative buoyancy tags may be circulated up from the bottom of the pulper to be captured by a pump-driven duct, a conveyor, rollers, or other means of vertical conveyance.

Wireless tags removed from certain pulpers may be cleaned before paper fibers have a chance to dry, hardening onto salvaged wireless tags, panels, inlays, carriers, or encapsulation shells. Tag testing and sorting steps may follow shortly thereafter.

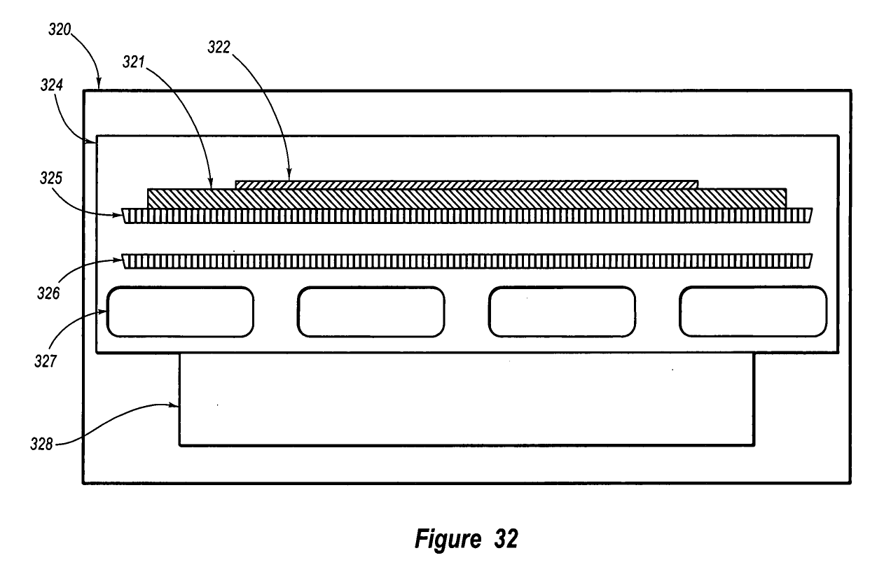

Referring to FIG. 32, an embodiment for wireless tag removal is illustrated in a sectional view, having a tank of substances at cold or cryogenic temperatures in various states (solid, liquid, or gas) to freeze adhesives which bind the tag to a transport container wall, such as corrugate. Wireless tag 322 is bonded to corrugate, a patch of corrugate, a carrier, a container, or a portion thereof 321 with an adhesive that may be temporarily deactivated at or near cryogenic temperatures. A variant of tank 320 can process tags attached to transport containers, such as metal cans, glass bottles or jars, or plastic bottles. Cryogenic tag removal device 320 may contain a cold fluid or a cryogenic solid, liquid, or gas 324 in sufficient quantities so as to fill tank 320 to a preferred level. Certain embodiments may use batch processing with a relatively small (wash-tub sized) tank. Certain embodiments for continuous high-capacity automated tag removal operations may use a large tank that may extend the full length of a room. Certain embodiments may use conveyor 325 and return belt path 326 to process incoming corrugated patches 321 and attached tags 322 through stages that may include: pre-chilling, immersion, cooling, and mechanical detachment.

If a cryogen is used, the specific type will typically depend on the type of tag and the object it is attached to. Liquid Nitrogen is one suitable cryogen since it is inert, readily available, and inexpensive. Atmospheric air may be used as a feedstock for the production of liquid nitrogen. Certain processes may be based on the distillation of compressed, purified, cooled, and separated air. Certain large scale embodiments of tank 320 include a dedicated infrastructure of liquid nitrogen (LIN) generators such as those manufactured by Stirling Cryogenics & Refrigeration BV of Son, The Netherlands. Certain LIN generators also produce liquid oxygen (LOX) since both are distilled from atmospheric air which is by volume 78.09% nitrogen, 20.95% oxygen. 0.93% argon, and 0.03% carbon dioxide. Certain tag reprocessing facilities having a dedicated LIN/LOX generator may use both LIN and LOX to cryogenically remove wireless tags from corrugate, glass, plastic, or metal containers or portions thereof.

One cryogen-saving step is to pre-chill tags and their associated containers before immersing them as part of a primary adhesive-freezing step, thereby reducing the required temperature change and thermal energy load on a subsequent cryogenic tag removal step. Certain methods may pre-chill tags using cryocoolers, pulse tube refrigeration systems, multi-stage refrigeration systems, closed cycle refrigerator systems, Joule-Thomson coolers, thermoelectric coolers, heat exchangers, Gifford-McMahon coolers, carbon dioxide pellet blast systems, or other thermal transfer systems.

Typical pressure sensitive adhesives adhere to most surfaces with very slight pressure and retain their tackiness above their melting point of about −65 to −90 degrees centigrade. Certain embodiments cool a solvent such as 95% pure ethyl alcohol to the desired temperature using coils 327 filled with a refrigerant or a cryogen such as liquefied nitrogen, helium, oxygen, or argon that is pumped through coils 327 at a preferred temperature, volume, rate, and pressure. Ethyl alcohol (ethanol) has a melting point of −144° C., and it becomes viscous at temperatures just above its melting point. Certain alternative embodiments of FIG. 32 may use a different configuration of tank 320 and mechanical motion for application of viscous cryogenic pastes.

Cryogenic tag removal device 320 may use some form of mechanical force. The force or motion may be used to break the adhesive bonds that are weakened by exposure to cryogenic or near cryogenic temperatures. The mechanical force may also be used to move a frozen detached tag in a desired manner as described below.

Mechanical force preferably does not disturb adhesives such as epoxy that are used to retain an RFID integrated circuit to the inlay substrate and assure good electrical contact with the antenna structure. Different types of mechanical force are preferred for different types of tags and the objects that the tags are attached to. A sweeping or spiral motion within a (near) cryogenic liquid may be used to create a vortex, turbulence, or even cavitation through the (near) cryogenic liquid to break adhesive bonds between the tag and its host object. Different implementations create varying amounts of suction, pressure, turbulence, bubbles, and vibration to dislodge the tag, preferably without exerting undo stress on the RFID IC's electrical or mechanical bonds.

Acoustic transducer 328 is included in some embodiments of tank 320. It provides a source of mechanical force that may be used instead of, or in combination with, the sweeping or spiral motions described above. Acoustic transducer 328 may operate at amplitudes, frequencies, and dwell times that produce the greatest yield and throughput of reusable tags for a particular tag type and object that it is attached to. Acoustic vibrations may be either audible or ultrasonic.

In these systems, care may be taken to prevent damage to adhesive bonds that are needed for reliable operation of a reused tag. Certain material handling, damping, wetting procedures, acoustic levels, and acoustic frequencies, may be preferred for various tag designs and applications.

Another type of mechanical force that is well-suited to some tag removal systems is a protruding member that shatters a (near) cryogenically frozen container.

Another type of mechanical force may come from within the frozen tag itself. Since the tag may be constructed of materials having different coefficients of thermal expansion (CTE), the induced stress between the layers of differing materials may cause a tag to curl. The amount of induced stress is governed by the equation:
σ=K(α1−α2)ΔT√(E1*E2*l/xa)

where:

σ is the induced stress

K is the geometric constant

α1 is the coefficient of thermal expansion of the plastic inlay substrate

α2 is the coefficient of thermal expansion of the (acrylate) adhesive

E1 is the modulus of elasticity of the adhesive

E2 is the modulus of elasticity of the plastic inlay substrate

l is the edge length of the substrate

xa is the thickness of the (acrylate) adhesive layer

The governing equation also applies to the stress induced by the CTE differences between the copper or aluminum antenna structures and each of the other two materials.

Approximations for the representative CTE's are (ppm/° C.):

Acrylate 171

PET 75

Copper 16

Aluminum 24

Although Copper and Aluminum do not vary from each other by more than 50%, they are 21-32% of PET and 9-14% of Acrylate. Therefore, depending on the specific tag structure, the induced stresses can be opposing each other considerably at cryogenic temperatures. Different tag structures may be detached using a (near) cryogenic removal process that is optimized for that design.

Another type of suitable mechanical force may be generated from the movement of the cryogenic liquid—or gas if it boils. A state transition to gas would occur as the cryogenic fluid is propelled toward the wireless tag through a nozzle. The volumetric liquid-to-gas expansion ratio of nitrogen is 710, argon is 860, helium is 780, and oxygen is 875. Certain methods of tag detachment may direct a cryogenic liquid or gas toward selected regions of the attached tag according to a preferred sequence in order to maximize yield and throughput. The velocity of movement may be relatively slow or fast. For example a “waterfall” of liquid nitrogen or a high velocity directed stream may be employed. Consideration may also be given to loss of cryogenic liquid to its gaseous state by such means.

Another type of suitable mechanical force is generated by moving an air mass across the top of a pool of (near) cryogenic liquid where tags are frozen and detached. Patches of corrugate after being frozen may be conveyed up above the (near) cryogenic liquid by conveyor 325/326. CTE stresses or externally applied forces may cause the tags to pop off and curl up. As the tags continue to ride on their frozen corrugate patches, they encounter an artificial cross wind that blows them into a cold recovery area. The frozen corrugate patches may then be allowed to warm up to room temperature as they re-enter an OCC waste stream.

The type, size, shape, and function of device 320 may be determined by the specific preferred process for removal of a certain tag from a certain transport container or portion thereof. Different wireless tags may have different materials and construction methods that make them more suitable to some embodiments and variants of device 320 than others.

Wireless tags may be interrogated, tested, and sorted, as described in step 58 of FIG. 5, for tag and container reuse within corrugate waste streams. Similarly, wireless tags in other waste streams including glass, plastic, metal, and aluminum may be interrogated to determine what type of tag is attached and what it is attached to. This information may be acquired by interrogating the tag to read certain manufacturer identification information, and reading the data payload to determine the product identity of the object that it is identifying. This information may then be used to query one or more databases to determine the preferred tag removal process and parameter settings.

Processes, devices, and configurations for removal of tags from glass bottles may be different than processes for removal of tags from corrugated cartons. For example, both types of products may be immersed in cryogenic fluid 324 of device 320, but the depth of immersion, orientation of the tag, exposure time, fluid temperature, acoustic excitation amplitudes, frequencies, dwell time, or methods of mechanically scraping tags from glass or plastic bottles may be adjusted to maximize tag yield, throughput, and longevity.

Without further elaboration, it is believed that one skilled in the art can use the preceding description to utilize the invention to its fullest extent. The examples and embodiments disclosed herein are to be construed as merely illustrative and not a limitation of the scope of the present invention in any way. It will be apparent to those having skill in the art that changes may be made to the details of the above-described embodiments without departing from the underlying principles of the invention. In other words, various modifications and improvements of the embodiments specifically disclosed in the description above are within the scope of the appended claims. The scope of the invention is therefore defined by the following claims.

1. A method for reusing wireless tags recovered during a waste recycling process, comprising:
receiving a container during a waste recycling process, wherein the container comprises a wireless tag attached to the container;
removing the wireless tag from the container;
categorizing the wireless tag for reuse;
mechanically reconditioning the wireless tag for reuse; and
logistically preparing the wireless tag for reuse.

2. The method of claim 1, wherein the step of removing the wireless tag comprises removing a portion of the container with the wireless tag, and wherein the wireless tag is mechanically reconditioned by removing at least some of the portion of the container from the wireless tag.

3. The method of claim 1, wherein the wireless tag is attached to the container with a permanent adhesive.

4. The method of claim 3, wherein the permanent adhesive comprises acrylate.

5. The method of claim 1, wherein the waste recycling process comprises a fiber repulping process.

6. The method of claim 5, wherein wireless tag is removed from the container before the container is repulped.

7. The method of claim 5, wherein the wireless tag is removed from the container during the repulping process.

8. The method of claim 1, wherein the container comprises at least one material selected from the group consisting of plastic, glass, and metal.

9. The method of claim 1, wherein the wireless tag is removed from the container by exposing at least a portion of the container to a cryogenic temperature.

10. The method of claim 1, wherein the step of categorizing the wireless tag for reuse comprises testing the wireless tag to determine whether it is suitable for reuse.

11. The method of claim 1, wherein the step of logistically preparing the wireless tag for reuse comprises data scrubbing.

12. The method of claim 1, wherein the container is selected from the group consisting of recyclable and biodegradable.

13. The method of claim 1, wherein the container comprises old corrugated carton (OCC) material.

14. The method of claim 1, wherein the step of categorizing the wireless tag for reuse comprises interrogating the wireless tag to extract information about the wireless tag.

15. The method of claim 14, wherein the information extracted from the wireless tag in interrogating the wireless tag is used to determine which additional processing steps will be used.

16. The method of claim 1, wherein the step of categorizing the wireless tag for reuse comprises sorting the wireless tag into one of at least two groups of wireless tags.

17. The method of claim 1, wherein the wireless tag is a radio frequency identification (RFID) tag.

18. A method for reusing wireless tags, comprising:
obtaining a pre-used wireless tag;
obtaining information from the wireless tag regarding at least one performance parameter;
assessing the information to determine whether the wireless tag is suitable for reuse; and
in response to determining that the wireless tag is suitable for reuse, attaching the wireless tag to a container.

19. The method of claim 18, further comprising:
sorting the wireless tag based on at least the condition of the wireless tag;
packaging the wireless tag with a collection of wireless tags, wherein each of the wireless tags in the collection comprises container material left over from previous uses;
removing at least a portion of container material from the wireless tag;
attaching the wireless tag to packing tape;
attaching the combined wireless tag and tape to a mesh;
repackaging the wireless tag;
transporting the wireless tag to a new location; and
programming the wireless tag with information to allow the container to be tracked.

20. The method of claim 19, wherein the wireless tag is repackaged into a roll.

21. The method of claim 19, wherein the wireless tag is repackaged into a cartridge.

22. The method of claim 18, further comprising programming the wireless tag with new information.

23. The method of claim 18, wherein the at least one performance parameter comprises a sensor performance of the wireless tag.

24. The method of claim 18, wherein the step of attaching the wireless tag to a container comprises bonding the wireless tag to the container using adhesive-backed tape.

25. The method of claim 18, wherein the step of obtaining information from the wireless tag comprises measuring the backscatter signal strength of the wireless tag.

26. The method of claim 25, wherein the step of obtaining information from the wireless tag comprises measuring a sensor performance of the wireless tag.

27. A method for facilitating reuse of wireless tags recovered during a waste recycling process, comprising:
receiving a plurality of wireless tags during a waste recycling process;
preparing the wireless tags for use by performing at least one of the following steps:
cleaning the wireless tags,
compressing a substrate under the wireless tags,
machining a substrate under the wireless tags,
releasing the adhesive bonds of the wireless tags by exposing the wireless tags to a cryogenic temperature, and
testing the wireless tags to determine whether the wireless tags are suitable for use;
extracting data from the wireless tags;
erasing data from the wireless tags; and
writing data to the wireless tags.

28. The method of claim 27, further comprising sorting the wireless tags into a plurality of groups of wireless tags, wherein the data extracted from the wireless tags is used to sort the wireless tags.

29. A method for reusing wireless tags, comprising:
obtaining a wireless tag;
testing the wireless tag to determine whether the wireless tag is suitable for use;
unlocking access to the wireless tag to allow for authorized users to rewrite information to the wireless tag;
writing and storing logistics information to the wireless tag;
locking access to the ability to rewrite information to the wireless tag;
attaching the wireless tag to a container; and
removing the wireless tag from the container for reuse.

30. A wireless tag, comprising:
a substrate comprising a cellulose fiber material, wherein the substrate is formed into a three-dimensional shape to allow the wireless tag to be inserted into a container adjacent to one or more objects in the container; and
a microstrip antenna connected to the substrate.

31. The wireless tag of claim 30, further comprising an intermediate substrate positioned between the substrate and the microstrip antenna.

32. The wireless tag of claim 30, further comprising a protective layer positioned over the microstrip antenna.

33. The wireless tag of claim 32, wherein the protective layer comprises a printed layer including printed information.

34. The wireless tag of claim 33, wherein the printed information comprises a barcode.

35. The wireless tag of claim 30, wherein the three-dimensional shape is generally polyhedron shaped.

36. The wireless tag of claim 30, wherein the three-dimensional shape is a “T” shape.

37. A recycle waste stream separation method, comprising:
electronically locating a wireless tag attached to a container; and
extracting the wireless tag from the container.

38. The method of claim 37, wherein the step of electronically locating a wireless tag comprises using an imager to receive information regarding the location and orientation of the wireless tag on the container.

39. The method of claim 38, wherein the imager penetrates container walls to reveal metallic antenna structures that are indicative of the physical location of any wireless tag within the imager's field of view.

40. The method of claim 38, wherein the imager detects and processes a marking on the container.

41. The method of claim 40, wherein the marking comprises a bar code.

42. The method of claim 40, wherein the marking is human readable.

43. The method of claim 37, wherein the step of electronically locating a wireless tag comprises interrogating the wireless tag to receive information regarding the location and orientation of the wireless tag on the container.

44. The method of claim 37, wherein the step of extracting the wireless tag from the container comprises cutting the wireless tag off of the container.

45. The method of claim 44, wherein a portion of the container is removed with the wireless tag.

46. The method of claim 37, wherein the step of extracting the wireless tag from the container comprises exposing at least a portion of the container to a cryogenic temperature.

47. The method of claim 37, wherein the step of extracting the wireless tag from the container comprises using an automated extraction device to remove the wireless tag from the container.

48. The method of claim 37, wherein the container comprises old corrugated carton (OCC) material.

49. The method of claim 37, wherein the wireless tag is a radio frequency identification (RFID) tag.

50. A system for removing wireless tags from containers in a recycle or reuse waste stream, comprising:
means for locating wireless tags attached to containers; and
automated means for removing permanently attached wireless tags from the containers.

51. The system of claim 50, wherein the means for locating wireless tags comprises an array of closely spaced near field couplers.

52. The system of claim 50, wherein the means for locating wireless tags comprises an array of closely spaced leaky coax.

53. The system of claim 50, wherein the automated means for removing the wireless tags comprises an automated cutter.
